(19) United States
(12) Patent Application Publication
(10) Pub. No.: US 2022/0095282 A1
(43) Pub. Date: Mar. 24, 2022

(54) METHOD AND APPARATUS FOR TRANSMITTING PPDU IN WIRELESS COMMUNICATION SYSTEM

(71) Applicant: LG ELECTRONICS INC., Seoul (KR)

(72) Inventors: Insun JANG, Seoul (KR); Jeongki KIM, Seoul (KR); Jinsoo CHOI, Seoul (KR); Dongguk LIM, Seoul (KR); Suhwook KIM, Seoul (KR); Eunsung PARK, Seoul (KR)

(73) Assignee: LG ELECTRONICS INC., Seoul (KR)

(21) Appl. No.: 17/310,382

(22) PCT Filed: Jan. 31, 2020
(86) PCT No.: PCT/KR2020/001498

§ 371 Date: Jul. 29, 2021

(30) Foreign Application Priority Data
Feb. 1, 2019 (KR) 10-2019-0013424
Feb. 12, 2019 (KR) 10-2019-0016327
Feb. 15, 2019 (KR) 10-2019-0018179
Mar. 28, 2019 (KR) 10-2019-0036297
May 7, 2019 (KR) 10-2019-0053260
Jun. 20, 2019 (KR) 10-2019-0073604
Sep. 3, 2019 (KR) 10-2019-0109183

(51) Int. Cl. H04W 72/04

(52) U.S. Cl. CPC H04W 72/04; H04W 84/12

(57) ABSTRACT

One example according to the present specification relates to a scheme for transmitting a PPDU in a wireless LAN (WLAN) system. A transmission STA can determine whether both a first channel and a second channel are idle. The transmission STA can configure backoff count values associated with the first channel and the second channel. The transmission STA can reduce the backoff count values on the basis of the first channel and the second channel. The transmission STA can transmit an NGV PPDU on the basis of the backoff count values.

### BACKGROUND OF THE DISCLOSURE

### Field of the Disclosure

The present disclosure relates to a technique of transmitting a PPDU in a wireless LAN system and, more particularly, to a method and apparatus for performing a channel sensing in a wireless LAN system.

### Related Art

Wireless network technologies may include various types of wireless local area networks (WLANs). The WLAN employs widely used networking protocols and can be used to interconnect nearby devices together. The various technical features described herein may be applied to any communication standard, such as WiFi or, more generally, any one of the IEEE 802.11 family of wireless protocols.

The present specification proposes technical features to improve the conventional IEEE 802.11p standard and technical features usable in a new communication standard. The new communication standard may be a Next Generation Vehicular or a Next Generation V2X Communication (NGV) standard that is being discussed recently.

Meanwhile, in the IEEE standard, various types or formats of Physical Protocol Data Units (PPDUs) are defined. The transmitting/receiving station (STA) has used an auto-detection rule to identify the type/format of the PPDU to be transmitted/received.

### SUMMARY

Particularly, in order to support Vehicle-to-Everything (V2X) smoothly in 5.9 GHz band, a technical development for a Next Generation Vehicular (NGV) has been progressing, in which a throughput improvement of DSRC (802.11p standard) and a high speed support are considered. In the NGV standard (i.e., 802.11bd standard), for 2× throughput improvement, a wide bandwidth (20 MHz) transmission, not the conventional 10 MHz transmission, has been considered. In addition, the NGV standard needs to support operations such as interoperability/backward compatibility/coexistence with the conventional 802.11p standard.

In the NGV standard, as a transmission bandwidth becomes greater, a discussion for a CCA/EDCA operation is required. That is, for the fairness with respect to STAs based on 802.11p standard, a detailed operation scheme may be requested.

An example according to the present disclosure relates to a method and apparatus for transmitting a PPDU in a wireless communication system.

A transmission STA according to an example of the present disclosure may determine whether both of a first channel set to 10 MHz and a second channel set to 10 MHz are idle.

A transmission STA according to an example of the present disclosure may decrease a backoff count value with respect to the first channel and the second channel based on the determination whether both the first channel and the second channel are idle.

A transmission STA according to an example of the present disclosure may transmit a Next Generation Vehicular (NGV) Physical Protocol Data Unit (PPDU) through the first channel and the second channel based on the condition that the backoff count value is set to a first value.

### Advantageous Effects

The present disclosure proposes a technical feature that supports a situation in which 5.9 GHz band is used in various wireless LAN systems (e.g., IEEE 802.11bd system). Based on various examples of the present disclosure, a throughput improvement of Dedicated Short Range Communication (DSRC) (802.11p) and a high speed may be supported for supporting V2X smoothly in 5.9 GHz band.

Particularly, according to the present disclosure, in a wireless LAN system, an STA may perform a channel sensing in multiple 10 MHz channels, and based on the channel sensing, may decrease a backoff count value. Accordingly, according to an example of the present disclosure, the fairness for an STA that supports the conventional standard is guaranteed, and the STA that supports a new standard may be able to coexist with the conventional STAs efficiently.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates an example of a PPDU used in an IEEE standard.

FIG. 5 illustrates a layout of resource units (RUs) used in a band of 20 MHz.

FIG. 6 illustrates a layout of RUs used in a band of 40 MHz.

FIG. 7 illustrates a layout of RUs used in a band of 80 MHz.

FIG. 8 illustrates a structure of an HE-SIG-B field.

FIG. 9 illustrates an example in which a plurality of user STAs are allocated to the same RU through a MU-MIMO scheme.

FIG. 10 illustrates an operation based on UL-MU.

FIG. 11 illustrates an example of a trigger frame.

FIG. 12 illustrates an example of a common information field of a trigger frame.

FIG. 13 illustrates an example of a subfield included in a per user information field.

FIG. 14 describes a technical feature of the UORA scheme.

FIG. 15 illustrates an example of a channel used/supported/defined within a 2.4 GHz band.

FIG. 16 illustrates an example of a channel used/supported/defined within a 5 GHz band.

FIG. 17 illustrates an example of a channel used/supported/defined within a 6 GHz band.

FIG. 18 illustrates an example of a PPDU used in the present specification.

FIG. 19 illustrates an example of a modified transmission device and/or receiving device of the present specification.

FIG. 20 is a diagram illustrating a channel access method based on EDCA.

FIG. 21 is a conceptual diagram illustrating a backoff operation/procedure of EDCA.

FIG. 22 is a diagram illustrating a backoff operation.

FIG. 23 illustrates a band plan of 5.9 GHz DSRC.

FIG. 24 illustrates the frame format according to 802.11bd standard.

FIG. 25 illustrates another format of the frame according to 802.11bd standard.

FIG. 26 is a diagram for describing an operation of the NGV STA.

FIG. 27 is another diagram for describing an operation of the NGV STA.

FIG. 28 is still another diagram for describing an operation of the NGV STA.

FIG. 29 is a flowchart for describing an operation of a transmission STA.

FIG. 30 illustrates a vehicle or autonomous driving vehicle applied to the present disclosure.

FIG. 31 illustrates an example of a vehicle based on the present disclosure.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may mean that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3rd generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

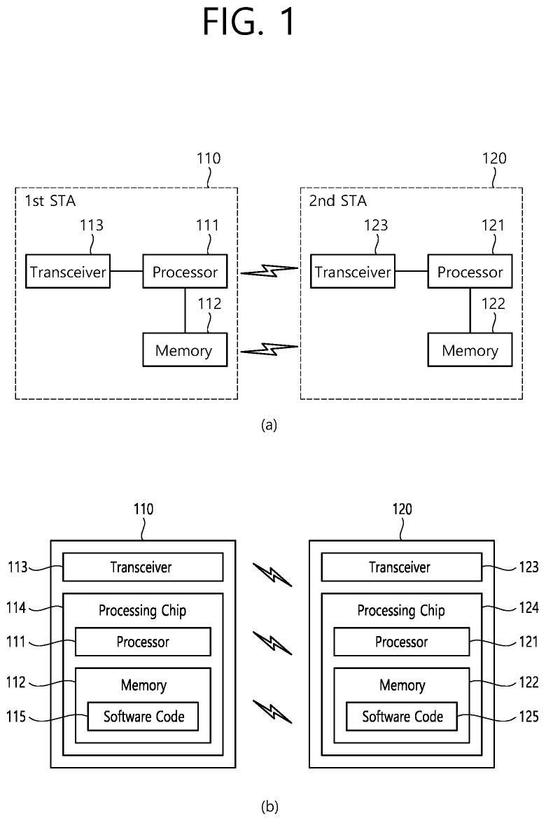

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP. In the present specification, the AP may be indicated as an AP STA.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

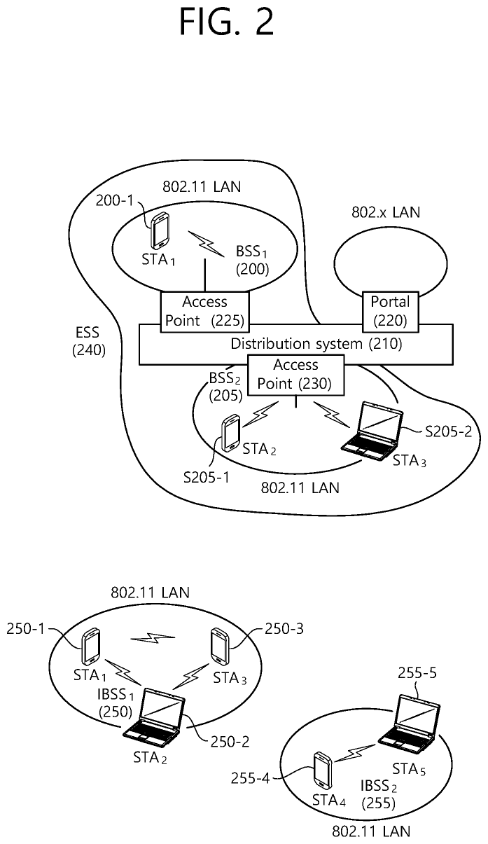

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

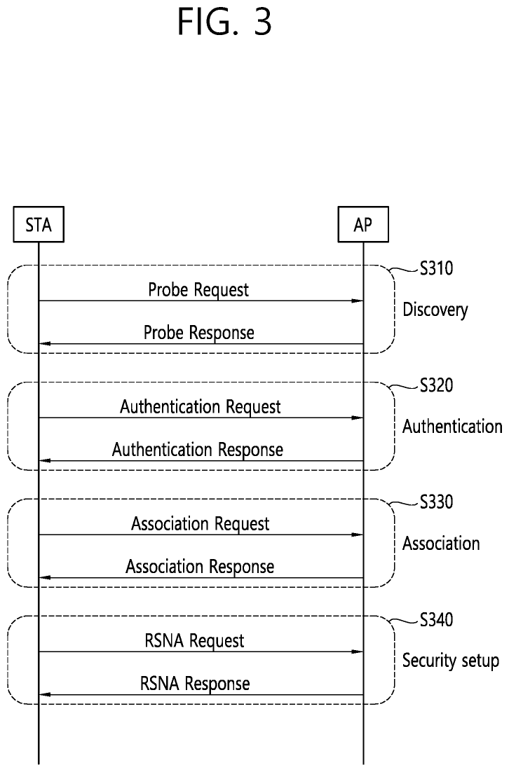

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

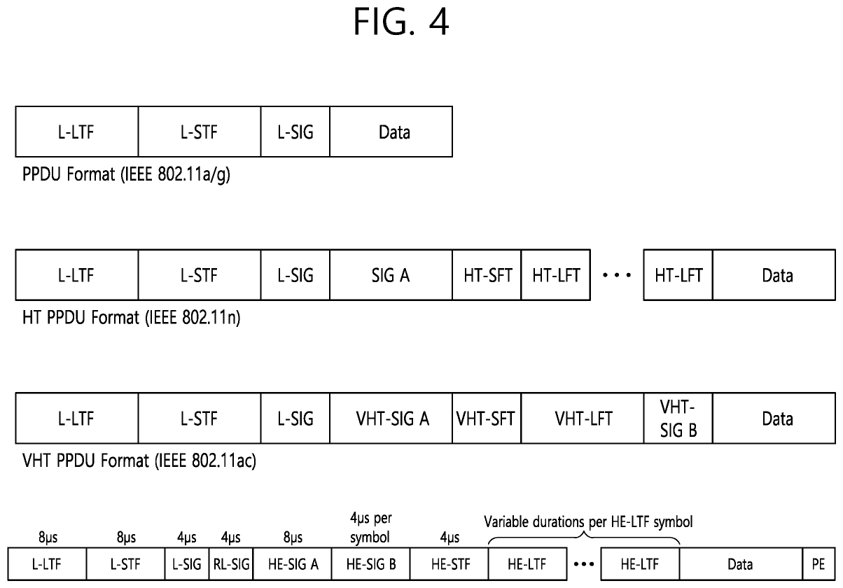

FIG. 4 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 4 also includes an example of an HE PPDU according to IEEE 802.11ax. The HE PPDU according to FIG. 4 is an illustrative PPDU for multiple users. An HE-SIG-B may be included only in a PPDU for multiple users, and an HE-SIG-B may be omitted in a PPDU for a single user.

As illustrated in FIG. 4, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

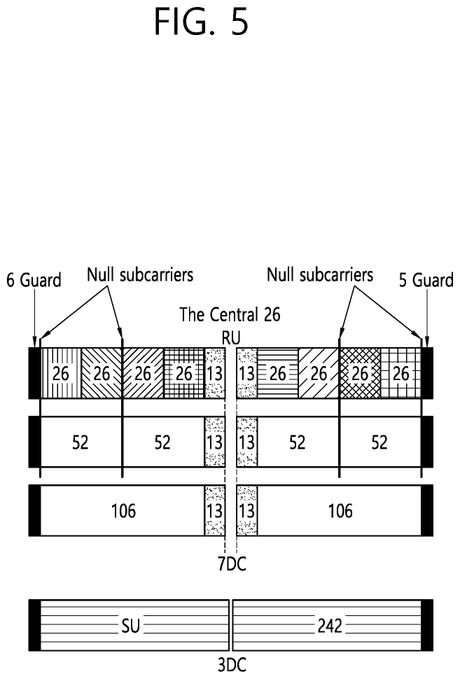

FIG. 5 illustrates a layout of resource units (RUs) used in a band of 20 MHz.

As illustrated in FIG. 5, resource units (RUs) corresponding to different numbers of tones (i.e., subcarriers) may be used to form some fields of an HE-PPDU. For example, resources may be allocated in illustrated RUs for an HE-STF, an HE-LTF, and a data field.

As illustrated in the uppermost part of FIG. 5, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the RUs in FIG. 5 may be used not only for a multiple users (MUs) but also for a single user (SU), in which case one 242-unit may be used and three DC tones may be inserted as illustrated in the lowermost part of FIG. 5.

Although FIG. 5 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones).

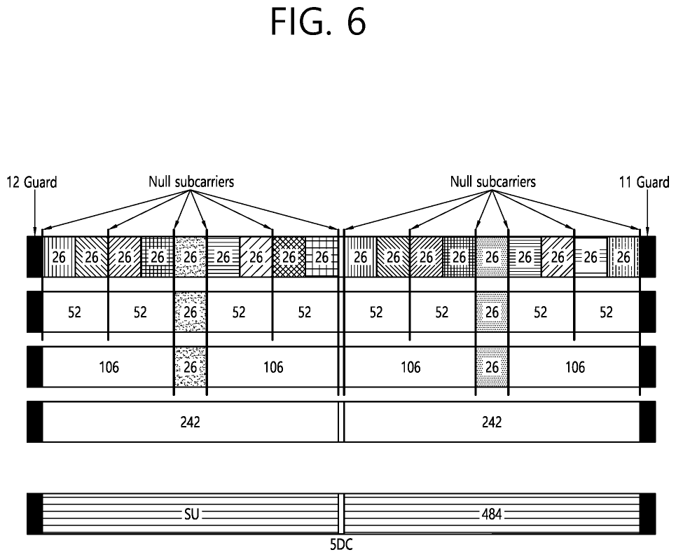

FIG. 6 illustrates a layout of RUs used in a band of 40 MHz.

Similar to FIG. 5 in which RUs having various sizes are used, a 26-RU, a 52-RU, a 106-RU, a 242-RU, a 484-RU, and the like may be used in an example of FIG. 6. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 6, when the layout of the RUs is used for a single user, a 484-RU may be used. The specific number of RUs may be changed similar to FIG. 5.

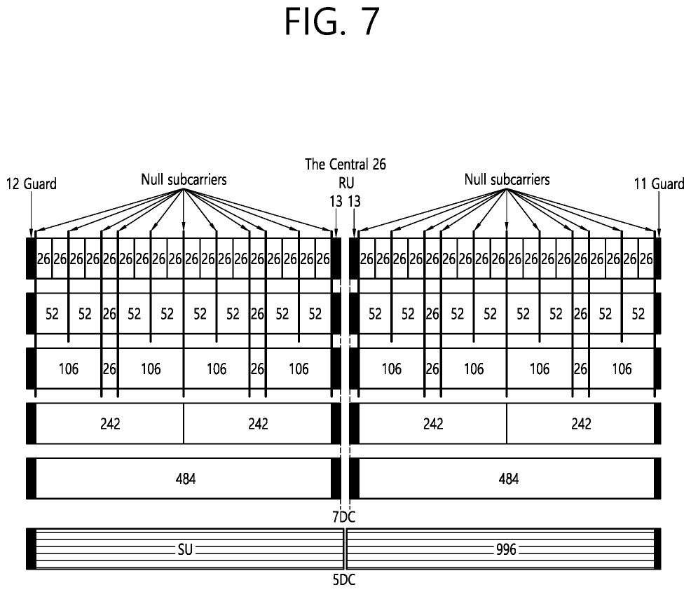

FIG. 7 illustrates a layout of RUs used in a band of 80 MHz.

Similar to FIG. 5 and FIG. 6 in which RUs having various sizes are used, a 26-RU, a 52-RU, a 106-RU, a 242-RU, a 484-RU, a 996-RU, and the like may be used in an example of FIG. 7. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

As illustrated in FIG. 7, when the layout of the RUs is used for a single user, a 996-RU may be used, in which case five DC tones may be inserted.

In the meantime, the fact that the specific number of RUs can be changed is the same as those of FIGS. 5 and 6.

The RU arrangement (i.e., RU location) shown in FIGS. 5 to 7 can be applied to a new wireless LAN system (e.g. EHT system) as it is. Meanwhile, for the 160 MHz band supported by the new WLAN system, the RU arrangement for 80 MHz (i.e., an example of FIG. 7) may be repeated twice, or the RU arrangement for the 40 MHz (i.e., an example of FIG. 6) may be repeated 4 times. In addition, when the EHT PPDU is configured for the 320 MHz band, the arrangement of the RU for 80 MHz (i.e., an example of FIG. 7) may be repeated 4 times or the arrangement of the RU for 40 MHz (i.e., an example of FIG. 6) may be repeated 8 times.

One RU of the present specification may be allocated for a single STA (e.g., a single non-AP STA). Alternatively, a plurality of RUs may be allocated for one STA (e.g., a non-AP STA).

The RU described in the present specification may be used in uplink (UL) communication and downlink (DL) communication. For example, when UL-MU communication which is solicited by a trigger frame is performed, a transmitting STA (e.g., an AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

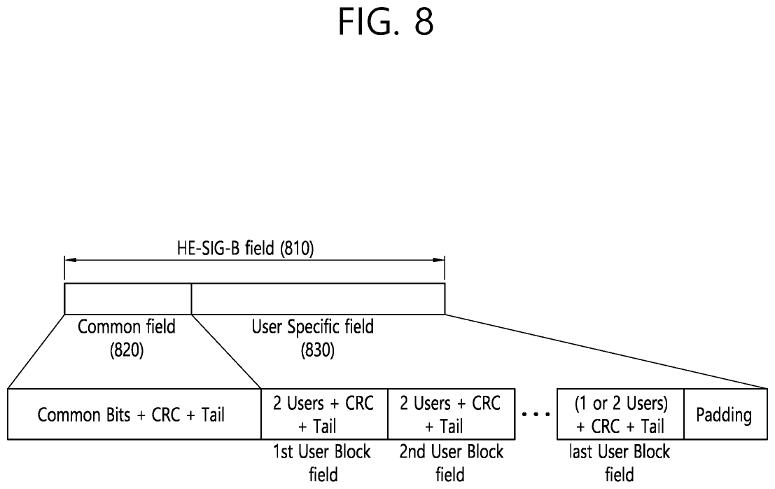

FIG. 8 illustrates a structure of an HE-SIG-B field.

As illustrated, an HE-SIG-B field 810 includes a common field 820 and a user-specific field 830. The common field 820 may include information commonly applied to all users (i.e., user STAs) which receive SIG-B. The user-specific field 830 may be called a user-specific control field. When the SIG-B is transferred to a plurality of users, the user-specific field 830 may be applied only any one of the plurality of users.

As illustrated in FIG. 8, the common field 820 and the user-specific field 830 may be separately encoded.

The common field 820 may include RU allocation information of N*8 bits. For example, the RU allocation information may include information related to a location of an RU. For example, when a 20 MHz channel is used as shown in FIG. 5, the RU allocation information may include information related to a specific frequency band to which a specific RU (26-RU/52-RU/106-RU) is arranged.

An example of a case in which the RU allocation information consists of 8 bits is as follows.

TABLE 1

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

As shown the example of FIG. 5, up to nine 26-RUs may be allocated to the 20 MHz channel. When the RU allocation information of the common field 820 is set to “00000000” as shown in Table 1, the nine 26-RUs may be allocated to a corresponding channel (i.e., 20 MHz). In addition, when the RU allocation information of the common field 820 is set to “00000001” as shown in Table 1, seven 26-RUs and one 52-RU are arranged in a corresponding channel. That is, in the example of FIG. 5, the 52-RU may be allocated to the rightmost side, and the seven 26-RUs may be allocated to the left thereof.

The example of Table 1 shows only some of RU locations capable of displaying the RU allocation information.

For example, the RU allocation information may include an example of Table 2 below.

TABLE 2

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |

| | | | | | | | |
|---|---|---|---|---|---|---|---|
| 01000y₂y₁y₀ | 106 | 26 | 26 | 26 | 26 | 26 | 8 |

| | | | | | | |
|---|---|---|---|---|---|---|
| 01001y₂y₁y₀ | 106 | 26 | 26 | 26 | 52 | 8 |

“01000y2y1y0” relates to an example in which a 106-RU is allocated to the leftmost side of the 20 MHz channel, and five 26-RUs are allocated to the right side thereof. In this case, a plurality of STAs (e.g., user-STAs) may be allocated to the 106-RU, based on a MU-MIMO scheme. Specifically, up to 8 STAs (e.g., user-STAs) may be allocated to the 106-RU, and the number of STAs (e.g., user-STAs) allocated to the 106-RU is determined based on 3-bit information (y2y1y0). For example, when the 3-bit information (y2y1y0) is set to N, the number of STAs (e.g., user-STAs) allocated to the 106-RU based on the MU-MIMO scheme may be N+1.

In general, a plurality of STAs (e.g., user STAs) different from each other may be allocated to a plurality of RUs. However, the plurality of STAs (e.g., user STAs) may be allocated to one or more RUs having at least a specific size (e.g., 106 subcarriers), based on the MU-MIMO scheme.

As shown in FIG. 8, the user-specific field 830 may include a plurality of user fields. As described above, the number of STAs (e.g., user STAs) allocated to a specific channel may be determined based on the RU allocation information of the common field 820. For example, when the RU allocation information of the common field 820 is “00000000”, one user STA may be allocated to each of nine 26-RUs (e.g., nine user STAs may be allocated). That is, up to 9 user STAs may be allocated to a specific channel through an OFDMA scheme. In other words, up to 9 user STAs may be allocated to a specific channel through a non-MU-MIMO scheme.

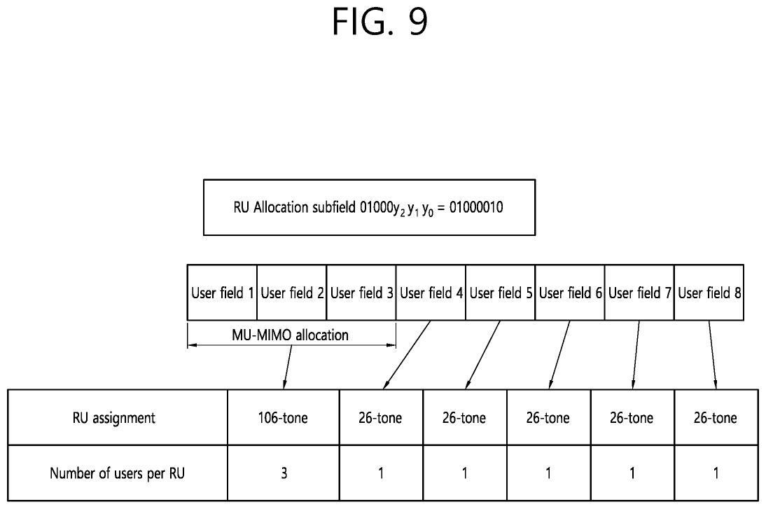

For example, when RU allocation is set to “01000y2y1y0”, a plurality of STAs may be allocated to the 106-RU arranged at the leftmost side through the MU-MIMO scheme, and five user STAs may be allocated to five 26-RUs arranged to the right side thereof through the non-MU MIMO scheme. This case is specified through an example of FIG. 9.

FIG. 9 illustrates an example in which a plurality of user STAs are allocated to the same RU through a MU-MIMO scheme.

For example, when RU allocation is set to “01000010” as shown in FIG. 9, a 106-RU may be allocated to the leftmost side of a specific channel, and five 26-RUs may be allocated to the right side thereof. In addition, three user STAs may be allocated to the 106-RU through the MU-MIMO scheme. As a result, since eight user STAs are allocated, the user-specific field 830 of HE-SIG-B may include eight user fields.

The eight user fields may be expressed in the order shown in FIG. 9. In addition, as shown in FIG. 8, two user fields may be implemented with one user block field.

The user fields shown in FIG. 8 and FIG. 9 may be configured based on two formats. That is, a user field related to a MU-MIMO scheme may be configured in a first format, and a user field related to a non-MIMO scheme may be configured in a second format. Referring to the example of FIG. 9, a user field 1 to a user field 3 may be based on the first format, and a user field 4 to a user field 8 may be based on the second format. The first format or the second format may include bit information of the same length (e.g., 21 bits).

Each user field may have the same size (e.g., 21 bits). For example, the user field of the first format (the first of the MU-MIMO scheme) may be configured as follows.

For example, a first bit (i.e., B0-B10) in the user field (i.e., 21 bits) may include identification information (e.g., STA-ID, partial AID, etc.) of a user STA to which a corresponding user field is allocated. In addition, a second bit (i.e., B11-B14) in the user field (i.e., 21 bits) may include information related to a spatial configuration. Specifically, an example of the second bit (i.e., B11-B14) may be as shown in Table 3 and Table 4 below.

TABLE 3

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 2 | 0000-0011 | 1-4 | 1 | | | | | | | 2-5 | 10 |
| | 0100-0110 | 2-4 | 2 | | | | | | | 4-6 | |
| | 0111-1000 | 3-4 | 3 | | | | | | | 6-7 | |
| | 1001 | 4 | 4 | | | | | | | 8 | |
| 3 | 0000-0011 | 1-4 | 1 | 1 | | | | | | 3-6 | 13 |
| | 0100-0110 | 2-4 | 2 | 1 | | | | | | 5-7 | |
| | 0111-1000 | 3-4 | 3 | 1 | | | | | | 7-8 | |
| | 1001-1011 | 2-4 | 2 | 2 | | | | | | 6-8 | |
| | 1100 | 3 | 3 | 2 | | | | | | 8 | |
| 4 | 0000-0011 | 1-4 | 1 | 1 | 1 | | | | | 4-7 | 11 |
| | 0100-0110 | 2-4 | 2 | 1 | 1 | | | | | 6-8 | |
| | 0111 | 3 | 3 | 1 | 1 | | | | | 8 | |
| | 1000-1001 | 2-3 | 2 | 2 | 1 | | | | | 7-8 | |
| | 1010 | 2 | 2 | 2 | 2 | | | | | 8 | |

TABLE 4

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 5 | 0000-0011 | 1-4 | 1 | 1 | 1 | 1 | | | | 5-8 | 7 |
| | 0100-0101 | 2-3 | 2 | 1 | 1 | 1 | | | | 7-8 | |
| | 0110 | 2 | 2 | 2 | 1 | 1 | | | | 8 | |
| 6 | 0000-0010 | 1-3 | 1 | 1 | 1 | 1 | 1 | | | 6-8 | 4 |
| | 0011 | 2 | 2 | 1 | 1 | 1 | 1 | | | 8 | |
| 7 | 0000-0001 | 1-2 | 1 | 1 | 1 | 1 | 1 | 1 | | 7-8 | 2 |
| 8 | 000 | 1 | 1 | 1 | 1 | 1 | 1 | 1 | 1 | 8 | 1 |

As shown in Table 3 and/or Table 4, the second bit (e.g., B11-B14) may include information related to the number of spatial streams allocated to the plurality of user STAs which are allocated based on the MU-MIMO scheme. For example, when three user STAs are allocated to the 106-RU based on the MU-MIMO scheme as shown in FIG. 9, N user is set to “3”. Therefore, values of N_STS[1], N_STS[2], and N_STS[3] may be determined as shown in Table 3. For example, when a values of the second bit (B11-B14) is “0011”, it may be set to N_STS[1]=4, N_STS[2]=1, N_STS[3]=1. That is, in the example of FIG. 9, four spatial streams may be allocated to the user field 1, one spatial stream may be allocated to the user field 1, and one spatial stream may be allocated to the user field 3.

As shown in the example of Table 3 and/or Table 4, information (i.e., the second bit, B11-B14) related to the number of spatial streams for the user STA may consist of 4 bits. In addition, the information (i.e., the second bit, B11-B14) on the number of spatial streams for the user STA may support up to eight spatial streams. In addition, the information (i.e., the second bit, B11-B14) on the number of spatial streams for the user STA may support up to four spatial streams for one user STA.

In addition, a third bit (i.e., B15-18) in the user field (i.e., 21 bits) may include modulation and coding scheme (MCS) information. The MCS information may be applied to a data field in a PPDU including corresponding SIG-B.

An MCS, MCS information, an MCS index, an MCS field, or the like used in the present specification may be indicated by an index value. For example, the MCS information may be indicated by an index 0 to an index 11. The MCS information may include information related to a constellation modulation type (e.g., BPSK, QPSK, 16-QAM, 64-QAM, 256-QAM, 1024-QAM, etc.) and information related to a coding rate (e.g., 1/2, 2/3, 3/4, 5/6e, etc.). Information related to a channel coding type (e.g., LCC or LDPC) may be excluded in the MCS information.

In addition, a fourth bit (i.e., B19) in the user field (i.e., 21 bits) may be a reserved field.

In addition, a fifth bit (i.e., B20) in the user field (i.e., 21 bits) may include information related to a coding type (e.g., BCC or LDPC). That is, the fifth bit (i.e., B20) may include information related to a type (e.g., BCC or LDPC) of channel coding applied to the data field in the PPDU including the corresponding SIG-B.

The aforementioned example relates to the user field of the first format (the format of the MU-MIMO scheme). An example of the user field of the second format (the format of the non-MU-MIMO scheme) is as follows.

A first bit (e.g., B0-B10) in the user field of the second format may include identification information of a user STA. In addition, a second bit (e.g., B11-B13) in the user field of the second format may include information related to the number of spatial streams applied to a corresponding RU. In addition, a third bit (e.g., B14) in the user field of the second format may include information related to whether a beamforming steering matrix is applied. A fourth bit (e.g., B15-B18) in the user field of the second format may include modulation and coding scheme (MCS) information. In addition, a fifth bit (e.g., B19) in the user field of the second format may include information related to whether dual carrier modulation (DCM) is applied. In addition, a sixth bit (i.e., B20) in the user field of the second format may include information related to a coding type (e.g., BCC or LDPC).

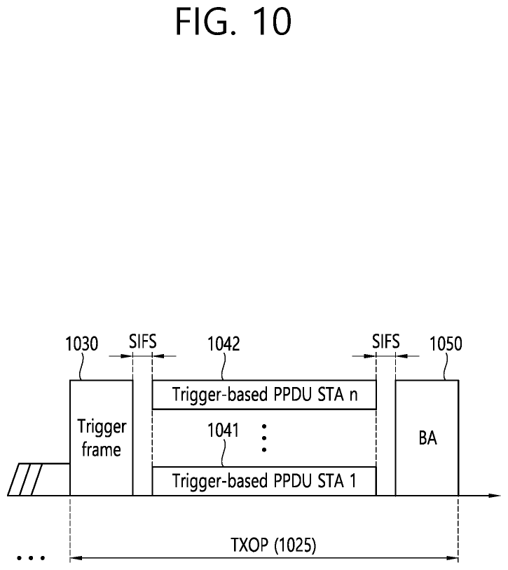

FIG. 10 illustrates an operation based on UL-MU. As illustrated, a transmitting STA (e.g., an AP) may perform channel access through contending (e.g., a backoff operation), and may transmit a trigger frame 1030. That is, the transmitting STA may transmit a PPDU including the trigger frame 1030. Upon receiving the PPDU including the trigger frame, a trigger-based (TB) PPDU is transmitted after a delay corresponding to SIFS.

TB PPDUs 1041 and 1042 may be transmitted at the same time period, and may be transmitted from a plurality of STAs (e.g., user STAs) having AIDs indicated in the trigger frame 1030. An ACK frame 1050 for the TB PPDU may be implemented in various forms.

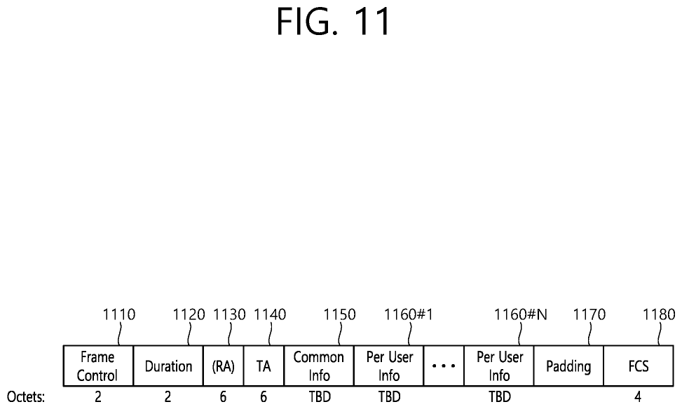

A specific feature of the trigger frame is described with reference to FIG. 11 to FIG. 13. Even if UL-MU communication is used, an orthogonal frequency division multiple access (OFDMA) scheme or a MU MIMO scheme may be used, and the OFDMA and MU-MIMO schemes may be simultaneously used.

FIG. 11 illustrates an example of a trigger frame. The trigger frame of FIG. 11 allocates a resource for uplink multiple-user (MU) transmission, and may be transmitted, for example, from an AP. The trigger frame may be configured of a MAC frame, and may be included in a PPDU.

Each field shown in FIG. 11 may be partially omitted, and another field may be added. In addition, a length of each field may be changed to be different from that shown in the figure.

A frame control field 1110 of FIG. 11 may include information related to a MAC protocol version and extra additional control information. A duration field 1120 may include time information for NAV configuration or information related to an identifier (e.g., AID) of a STA.

In addition, an RA field 1130 may include address information of a receiving STA of a corresponding trigger frame, and may be optionally omitted. A TA field 1140 may include address information of a STA (e.g., an AP) which transmits the corresponding trigger frame. A common information field 1150 includes common control information applied to the receiving STA which receives the corresponding trigger frame. For example, a field indicating a length of an L-SIG field of an uplink PPDU transmitted in response to the corresponding trigger frame or information for controlling content of an SIG-A field (i.e., HE-SIG-A field) of the uplink PPDU transmitted in response to the corresponding trigger frame may be included. In addition, as common control information, information related to a length of a CP of the uplink PPDU transmitted in response to the corresponding trigger frame or information related to a length of an LTF field may be included.

In addition, per user information fields 1160 #1 to 1160 #N corresponding to the number of receiving STAs which receive the trigger frame of FIG. 11 are preferably included. The per user information field may also be called an “allocation field”.

In addition, the trigger frame of FIG. 11 may include a padding field 1170 and a frame check sequence field 1180.

Each of the per user information fields 1160 #1 to 1160 #N shown in FIG. 11 may include a plurality of subfields.

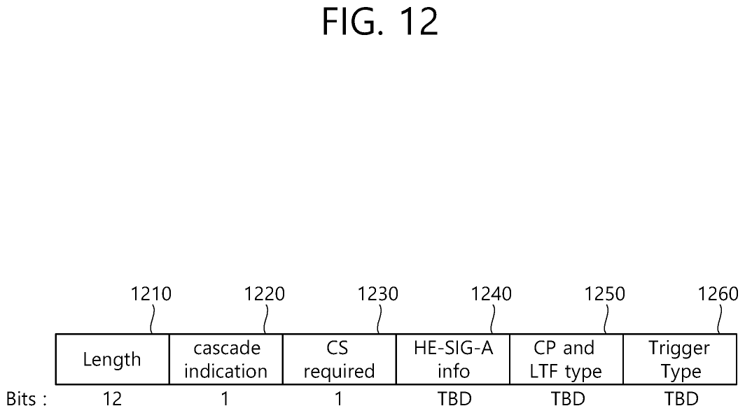

FIG. 12 illustrates an example of a common information field of a trigger frame. A subfield of FIG. 12 may be partially omitted, and an extra subfield may be added. In addition, a length of each subfield illustrated may be changed.

A length field 1210 illustrated has the same value as a length field of an L-SIG field of an uplink PPDU transmitted in response to a corresponding trigger frame, and a length field of the L-SIG field of the uplink PPDU indicates a length of the uplink PPDU. As a result, the length field 1210 of the trigger frame may be used to indicate the length of the corresponding uplink PPDU.

In addition, a cascade identifier field 1220 indicates whether a cascade operation is performed. The cascade operation implies that downlink MU transmission and uplink MU transmission are performed together in the same TXOP. That is, it implies that downlink MU transmission is performed and thereafter uplink MU transmission is performed after a pre-set time (e.g., SIFS). During the cascade operation, only one transmitting device (e.g., AP) may perform downlink communication, and a plurality of transmitting devices (e.g., non-APs) may perform uplink communication.

A CS request field 1230 indicates whether a wireless medium state or an NAV or the like is necessarily considered in a situation where a receiving device which has received a corresponding trigger frame transmits a corresponding uplink PPDU.

An HE-SIG-A information field 1240 may include information for controlling content of an SIG-A field (i.e., HE-SIG-A field) of the uplink PPDU in response to the corresponding trigger frame.

A CP and LTF type field 1250 may include information related to a CP length and LTF length of the uplink PPDU transmitted in response to the corresponding trigger frame. A trigger type field 1260 may indicate a purpose of using the corresponding trigger frame, for example, typical triggering, triggering for beamforming, a request for block ACK/NACK, or the like.

It may be assumed that the trigger type field 1260 of the trigger frame in the present specification indicates a trigger frame of a basic type for typical triggering. For example, the trigger frame of the basic type may be referred to as a basic trigger frame.

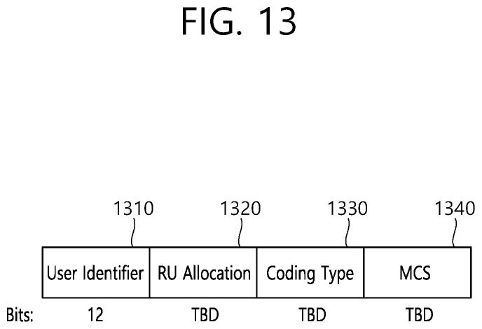

FIG. 13 illustrates an example of a subfield included in a per user information field. A user information field 1300 of FIG. 13 may be understood as any one of the per user information fields 1160 #1 to 1160 #N mentioned above with reference to FIG. 11. A subfield included in the user information field 1300 of FIG. 13 may be partially omitted, and an extra subfield may be added. In addition, a length of each subfield illustrated may be changed.

A user identifier field 1310 of FIG. 13 indicates an identifier of a STA (i.e., receiving STA) corresponding to per user information. An example of the identifier may be the entirety or part of an association identifier (AID) value of the receiving STA.

In addition, an RU allocation field 1320 may be included. That is, when the receiving STA identified through the user identifier field 1310 transmits a TB PPDU in response to the trigger frame, the TB PPDU is transmitted through an RU indicated by the RU allocation field 1320. In this case, the RU indicated by the RU allocation field 1320 may be an RU shown in FIG. 5, FIG. 6, and FIG. 7.

The subfield of FIG. 13 may include a coding type field 1330. The coding type field 1330 may indicate a coding type of the TB PPDU. For example, when BCC coding is applied to the TB PPDU, the coding type field 1330 may be set to ‘1’, and when LDPC coding is applied, the coding type field 1330 may be set to ‘0’.

In addition, the subfield of FIG. 13 may include an MCS field 1340. The MCS field 1340 may indicate an MCS scheme applied to the TB PPDU. For example, when BCC coding is applied to the TB PPDU, the coding type field 1330 may be set to ‘1’, and when LDPC coding is applied, the coding type field 1330 may be set to ‘0’.

Hereinafter, a UL OFDMA-based random access (UORA) scheme will be described.

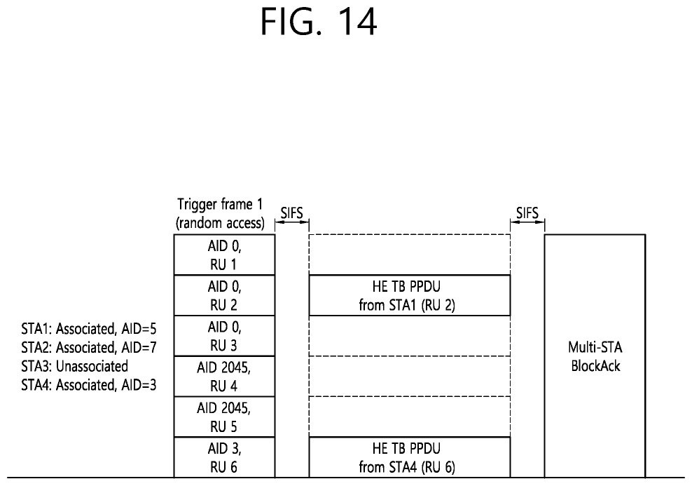

FIG. 14 describes a technical feature of the UORA scheme.

A transmitting STA (e.g., an AP) may allocate six RU resources through a trigger frame as shown in FIG. 14. Specifically, the AP may allocate a 1st RU resource (AID 0, RU 1), a 2nd RU resource (AID 0, RU 2), a 3rd RU resource (AID 0, RU 3), a 4th RU resource (AID 2045, RU 4), a 5th RU resource (AID 2045, RU 5), and a 6th RU resource (AID 3, RU 6). Information related to the AID 0, AID 3, or AID 2045 may be included, for example, in the user identifier field 1310 of FIG. 13. Information related to the RU 1 to RU 6 may be included, for example, in the RU allocation field 1320 of FIG. 13. AID=0 may imply a UORA resource for an associated STA, and AID=2045 may imply a UORA resource for an un-associated STA. Accordingly, the 1st to 3rd RU resources of FIG. 14 may be used as a UORA resource for the associated STA, the 4th and 5th RU resources of FIG. 14 may be used as a UORA resource for the un-associated STA, and the 6th RU resource of FIG. 14 may be used as a typical resource for UL MU.

In the example of FIG. 14, an OFDMA random access backoff (OBO) of a STA1 is decreased to 0, and the STA1 randomly selects the 2nd RU resource (AID 0, RU 2). In addition, since an OBO counter of a STA2/3 is greater than 0, an uplink resource is not allocated to the STA2/3. In addition, regarding a STA4 in FIG. 14, since an AID (e.g., AID=3) of the STA4 is included in a trigger frame, a resource of the RU 6 is allocated without backoff.

Specifically, since the STA1 of FIG. 14 is an associated STA, the total number of eligible RA RUs for the STA1 is 3 (RU 1, RU 2, and RU 3), and thus the STA1 decreases an OBO counter by 3 so that the OBO counter becomes 0. In addition, since the STA2 of FIG. 14 is an associated STA, the total number of eligible RA RUs for the STA2 is 3 (RU 1, RU 2, and RU 3), and thus the STA2 decreases the OBO counter by 3 but the OBO counter is greater than 0. In addition, since the STA3 of FIG. 14 is an un-associated STA, the total number of eligible RA RUs for the STA3 is 2 (RU 4, RU 5), and thus the STA3 decreases the OBO counter by 2 but the OBO counter is greater than 0.

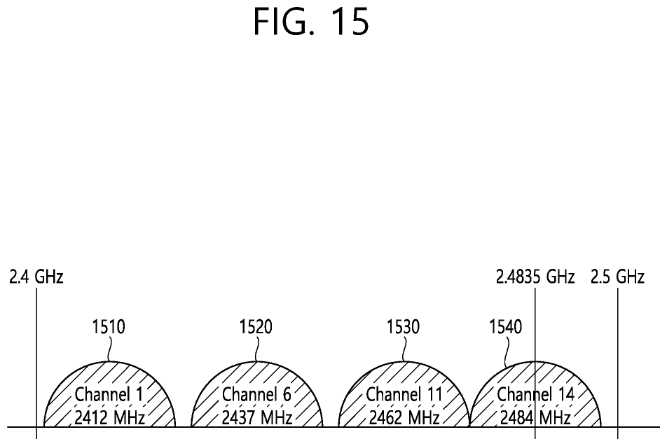

FIG. 15 illustrates an example of a channel used/supported/defined within a 2.4 GHz band.

The 2.4 GHz band may be called in other terms such as a first band. In addition, the 2.4 GHz band may imply a frequency domain in which channels of which a center frequency is close to 2.4 GHz (e.g., channels of which a center frequency is located within 2.4 to 2.5 GHz) are used/supported/defined.

A plurality of 20 MHz channels may be included in the 2.4 GHz band. 20 MHz within the 2.4 GHz may have a plurality of channel indices (e.g., an index 1 to an index 14). For example, a center frequency of a 20 MHz channel to which a channel index 1 is allocated may be 2.412 GHz, a center frequency of a 20 MHz channel to which a channel index 2 is allocated may be 2.417 GHz, and a center frequency of a 20 MHz channel to which a channel index N is allocated may be (2.407+0.005*N) GHz. The channel index may be called in various terms such as a channel number or the like. Specific numerical values of the channel index and center frequency may be changed.

FIG. 15 exemplifies 4 channels within a 2.4 GHz band. Each of 1st to 4th frequency domains 1510 to 1540 shown herein may include one channel. For example, the 1st frequency domain 1510 may include a channel 1 (a 20 MHz channel having an index 1). In this case, a center frequency of the channel 1 may be set to 2412 MHz. The 2nd frequency domain 1520 may include a channel 6. In this case, a center frequency of the channel 6 may be set to 2437 MHz. The 3rd frequency domain 1530 may include a channel 11. In this case, a center frequency of the channel 11 may be set to 2462 MHz. The 4th frequency domain 1540 may include a channel 14. In this case, a center frequency of the channel 14 may be set to 2484 MHz.

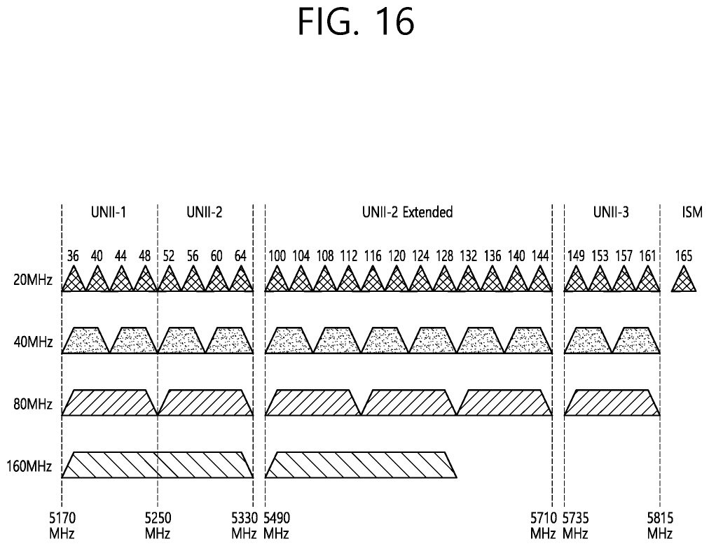

FIG. 16 illustrates an example of a channel used/supported/defined within a 5 GHz band.

The 5 GHz band may be called in other terms such as a second band or the like. The 5 GHz band may imply a frequency domain in which channels of which a center frequency is greater than or equal to 5 GHz and less than 6 GHz (or less than 5.9 GHz) are used/supported/defined. Alternatively, the 5 GHz band may include a plurality of channels between 4.5 GHz and 5.5 GHz. A specific numerical value shown in FIG. 16 may be changed.

A plurality of channels within the 5 GHz band include an unlicensed national information infrastructure (UNII)-1, a UNII-2, a UNII-3, and an ISM. The INII-1 may be called UNIT Low. The UNII-2 may include a frequency domain called UNIT Mid and UNIT-2Extended. The UNII-3 may be called UNII-Upper.

A plurality of channels may be configured within the 5 GHz band, and a bandwidth of each channel may be variously set to, for example, 20 MHz, 40 MHz, 80 MHz, 160 MHz, or the like. For example, 5170 MHz to 5330 MHz frequency domains/ranges within the UNIT-1 and UNII-2 may be divided into eight 20 MHz channels. The 5170 MHz to 5330 MHz frequency domains/ranges may be divided into four channels through a 40 MHz frequency domain. The 5170 MHz to 5330 MHz frequency domains/ranges may be divided into two channels through an 80 MHz frequency domain. Alternatively, the 5170 MHz to 5330 MHz frequency domains/ranges may be divided into one channel through a 160 MHz frequency domain.

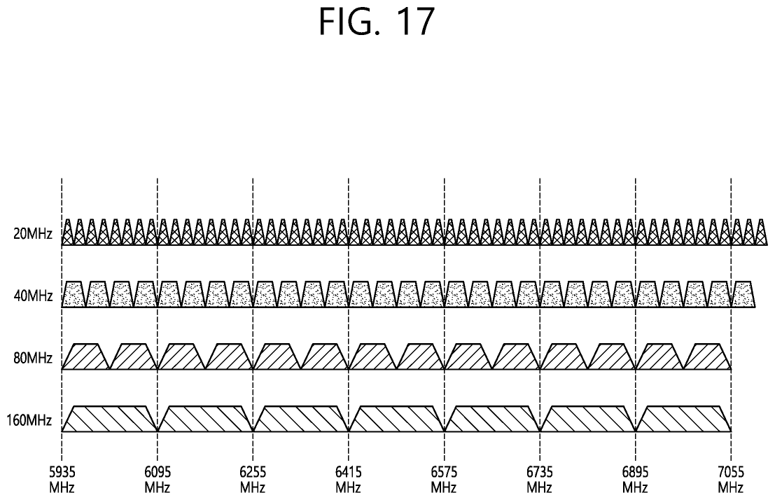

FIG. 17 illustrates an example of a channel used/supported/defined within a 6 GHz band.

The 6 GHz band may be called in other terms such as a third band or the like. The 6 GHz band may imply a frequency domain in which channels of which a center frequency is greater than or equal to 5.9 GHz are used/supported/defined. A specific numerical value shown in FIG. 17 may be changed.

For example, the 20 MHz channel of FIG. 17 may be defined starting from 5.940 GHz. Specifically, among 20 MHz channels of FIG. 17, the leftmost channel may have an index 1 (or a channel index, a channel number, etc.), and 5.945 GHz may be assigned as a center frequency. That is, a center frequency of a channel of an index N may be determined as (5.940+0.005*N) GHz.

Accordingly, an index (or channel number) of the 2 MHz channel of FIG. 17 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. In addition, according to the aforementioned (5.940+0.005*N) GHz rule, an index of the 40 MHz channel of FIG. 17 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

Although 20, 40, 80, and 160 MHz channels are illustrated in the example of FIG. 17, a 240 MHz channel or a 320 MHz channel may be additionally added.

Hereinafter, a PPDU transmitted/received in a STA of the present specification will be described.

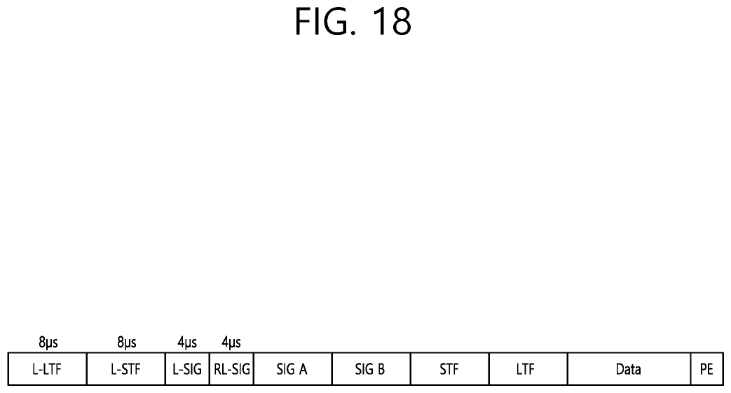

FIG. 18 illustrates an example of a PPDU used in the present specification.

The PPDU depicted in FIG. 18 may be referred to as various terms such as an EHT PPDU, a TX PPDU, an RX PPDU, a first type or N-th type PPDU, or the like. In addition, the EHT PPDU may be used in an EHT system and/or a new WLAN system enhanced from the EHT system.

The subfields depicted in FIG. 18 may be referred to as various terms. For example, a SIG A field may be referred to an EHT-SIG-A field, a SIG B field may be referred to an EHT-SIG-B, a STF field may be referred to an EHT-STF field, and an LTF field may be referred to an EHT-LTF.

The subcarrier spacing of the L-LTF, L-STF, L-SIG, and RL-SIG fields of FIG. 18 can be set to 312.5 kHz, and the subcarrier spacing of the STF, LTF, and Data fields of FIG. 18 can be set to 78.125 kHz. That is, the subcarrier index of the L-LTF, L-STF, L-SIG, and RL-SIG fields can be expressed in unit of 312.5 kHz, and the subcarrier index of the STF, LTF, and Data fields can be expressed in unit of 78.125 kHz.

The SIG A and/or SIG B fields of FIG. 18 may include additional fields (e.g., a SIG C field or one control symbol, etc.). The subcarrier spacing of all or part of the SIG A and SIG B fields may be set to 312.5 kHz, and the subcarrier spacing of all or part of newly-defined SIG field(s) may be set to 312.5 kHz. Meanwhile, the subcarrier spacing for a part of the newly-defined SIG field(s) may be set to a pre-defined value (e.g., 312.5 kHz or 78.125 kHz).

In the PPDU of FIG. 18, the L-LTF and the L-STF may be the same as conventional L-LTF and L-STF fields.

The L-SIG field of FIG. 18 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to the number of octets of a corresponding Physical Service Data Unit (PSDU). For example, the length field of 12 bits may be determined based on a type of the PPDU. For example, when the PPDU is a non-HT, HT, VHT PPDU or an EHT PPDU, a value of the length field may be determined as a multiple of 3. For example, when the PPDU is an HE PPDU, the value of the length field may be determined as ‘a multiple of 3+1’ or ‘a multiple of 3+2’. In other words, for the non-HT, HT, VHT PPDI or the EHT PPDU, the value of the length field may be determined as ‘a multiple of 3’, and for the HE PPDU, the value of the length field may be determined as ‘a multiple of 3+1’ or ‘a multiple of 3+2’.

For example, the transmitting STA may apply BCC encoding based on a ½ coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index {−28, −27, +27, +28}. The aforementioned signal may be used for channel estimation on a frequency domain corresponding to {−28, −27, +27, +28}.

The transmitting STA may generate an RL-SIG which is identical to the L-SIG. BPSK modulation may be applied to the RL-SIG. The receiving STA may figure out that the RX PPDU is the HE PPDU or the EHT PPDU, based on the presence of the RL-SIG.

After the RL-SIG of FIG. 18, for example, EHT-SIG-A or one control symbol may be inserted. A symbol contiguous to the RL-SIG (i.e., EHT-SIG-A or one control symbol) may include 26 bit information and may further include information for identifying the type of the EHT PPDU. For example, when the EHT PPDU is classified into various types (e.g., an EHT PPDU supporting an SU mode, an EHT PPDU supporting a MU mode, an EHT PPDU related to the Trigger Frame, an EHT PPDU related to an Extended Range transmission, etc.), Information related to the type of the EHT PPDU may be included in a symbol contiguous to the RL-SIG.

A symbol contiguous to the RL-SIG may include, for example, information related to the length of the TXOP and information related to the BSS color ID. For example, the SIG-A field may be contiguous to the symbol contiguous to the RL-SIG (e.g., one control symbol). Alternatively, a symbol contiguous to the RL-SIG may be the SIG-A field.

For example, the SIG-A field may include 1) a DL/UL indicator, 2) a BSS color field which is an identifier of a BSS, 3) a field including information related to the remaining time of a current TXOP duration, 4) a bandwidth field including information related to the bandwidth, 5) a field including information related to an MCS scheme applied to an HE-SIG B, 6) a field including information related to whether a dual subcarrier modulation (DCM) scheme is applied to the HE-SIG B, 7) a field including information related to the number of symbols used for the HE-SIG B, 8) a field including information related to whether the HE-SIG B is generated over the entire band, 9) a field including information related to the type of the LTF/STF, 10) a field indicating the length of the HE-LTF and a CP length.

The SIG-B of FIG. 18 may include the technical features of HE-SIG-B shown in the example of FIGS. 8 to 9 as it is.

An STF of FIG. 18 may be used to improve automatic gain control estimation in a multiple input multiple output (MIMO) environment or an OFDMA environment. An LTF of FIG. 18 may be used to estimate a channel in the MIMO environment or the OFDMA environment.

The EHT-STF of FIG. 18 may be set in various types. For example, a first type of STF (e.g., 1×STF) may be generated based on a first type STF sequence in which a non-zero coefficient is arranged with an interval of 16 subcarriers. An STF signal generated based on the first type STF sequence may have a period of 0.8 μs, and a periodicity signal of 0.8 μs may be repeated 5 times to become a first type STF having a length of 4 μs. For example, a second type of STF (e.g., 2×STF) may be generated based on a second type STF sequence in which a non-zero coefficient is arranged with an interval of 8 subcarriers. An STF signal generated based on the second type STF sequence may have a period of 1.6 μs, and a periodicity signal of 1.6 μs may be repeated 5 times to become a second type STF having a length of 8 μs. For example, a third type of STF (e.g., 4×STF) may be generated based on a third type STF sequence in which a non-zero coefficient is arranged with an interval of 4 subcarriers. An STF signal generated based on the third type STF sequence may have a period of 3.2 μs, and a periodicity signal of 3.2 μs may be repeated 5 times to become a second type STF having a length of 16 μs. Only some of the first to third type EHT-STF sequences may be used. In addition, the EHT-LTF field may also have first, second, and third types (i.e., 1×, 2×, 4×LTF). For example, the first/second/third type LTF field may be generated based on an LTF sequence in which a non-zero coefficient is arranged with an interval of 4/2/1 subcarriers. The first/second/third type LTF may have a time length of 3.2/6.4/12.8 μs. In addition, Guard Intervals (GIs) with various lengths (e.g., 0.8/1/6/3.2 μs) may be applied to the first/second/third type LTF.

Information related to the type of STF and/or LTF (including information related to GI applied to the LTF) may be included in the SIG A field and/or the SIG B field of FIG. 18.

The PPDU of FIG. 18 may support various bandwidths. For example, the PPDU of FIG. 18 may have a bandwidth of 20/40/80/160/240/320 MHz. For example, at least one field (e.g., STF, LTF, data) of FIG. 18 may be configured based on RUs illustrated in FIGS. 5 to 7, and the like. For example, when there is one receiving STA of the PPDU of FIG. 18, all fields of the PPDU of FIG. 18 may occupy the entire bandwidth. For example, when there are multiple receiving STAs of the PPDU of FIG. 18 (i.e., when MU PPDU is used), some fields (e.g., STF, LTF, data) of FIG. 18 may be configured based on the RUs shown in FIGS. 5 to 7. For example, the STF, LTF, and data fields for the first receiving STA of the PPDU may be transmitted/received through a first RU, and the STF, LTF, and data fields for the second receiving STA of the PPDU may be transmitted/received through a second RU. In this case, the locations/positions of the first and second RUs may be determined based on FIGS. 5 to 7, and the like.

The PPDU of FIG. 18 may be determined (or identified) as an EHT PPDU based on the following method.

A receiving STA may determine a type of an RX PPDU as the EHT PPDU, based on the following aspect. For example, the RX PPDU may be determined as the EHT PPDU: 1) when a first symbol after an L-LTF signal of the RX PPDU is a BPSK symbol; 2) when RL-SIG in which the L-SIG of the RX PPDU is repeated is detected; and 3) when a result of applying “module 3” to a value of a length field of the L-SIG of the RX PPDU is detected as “0”. When the RX PPDU is determined as the EHT PPDU, the receiving STA may detect a type of the EHT PPDU (e.g., an SU/MU/Trigger-based/Extended Range type), based on bit information included in a symbol after the RL-SIG of FIG. 18. In other words, the receiving STA may determine the RX PPDU as the EHT PPDU, based on: 1) a first symbol after an L-LTF signal, which is a BPSK symbol; 2) RL-SIG contiguous to the L-SIG field and identical to L-SIG; and 3) L-SIG including a length field in which a result of applying “modulo 3” is set to “0.”

For example, the receiving STA may determine the type of the RX PPDU as the EHT PPDU, based on the following aspect. For example, the RX PPDU may be determined as the HE PPDU: 1) when a first symbol after an L-LTF signal is a BPSK symbol; 2) when RL-SIG in which the L-SIG is repeated is detected; and 3) when a result of applying “module 3” to a value of a length field of the L-SIG is detected as “1” or “2”.

For example, the receiving STA may determine the type of the RX PPDU as a non-HT, HT, and VHT PPDU, based on the following aspect. For example, the RX PPDU may be determined as the non-HT, HT, and VHT PPDU: 1) when a first symbol after an L-LTF signal is a BPSK symbol; and 2) when RL-SIG in which L-SIG is repeated is not detected. In addition, even if the receiving STA detects that the RL-SIG is repeated, when a result of applying “modulo 3” to the length value of the L-SIG is detected as “0”, the RX PPDU may be determined as the non-HT, HT, and VHT PPDU.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 18. The PPDU of FIG. 18 may be used to transmit/receive frames of various types. For example, the PPDU of FIG. 18 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 18 may be used for a management frame. An example of the management frame may include a beacon frame, a (re-)association request frame, a (re-)association response frame, a probe request frame, and a probe response frame. For example, the PPDU of FIG. 18 may be used for a data frame. For example, the PPDU of FIG. 18 may be used to simultaneously transmit at least two or more of the control frame, the management frame, and the data frame.

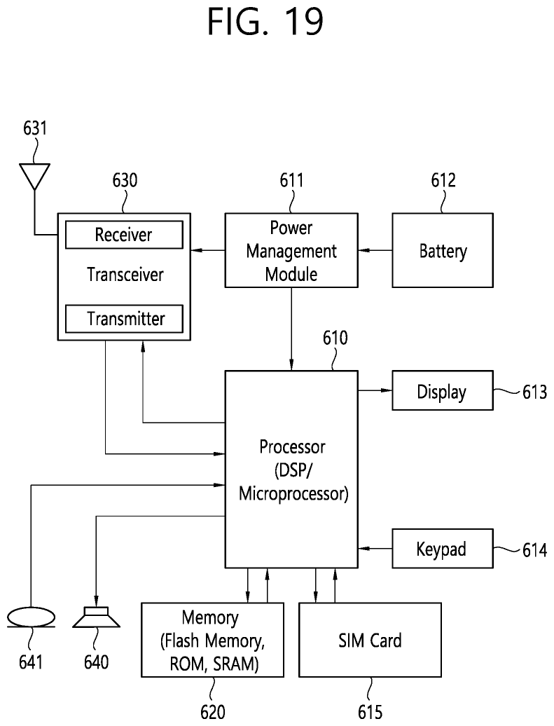

FIG. 19 illustrates an example of a modified transmission device and/or receiving device of the present specification.

Each device/STA of the sub-figure (a)/(b) of FIG. 1 may be modified as shown in FIG. 19. A transceiver 630 of FIG. 19 may be identical to the transceivers 113 and 123 of FIG. 1. The transceiver 630 of FIG. 19 may include a receiver and a transmitter.

A processor 610 of FIG. 19 may be identical to the processors 111 and 121 of FIG. 1. Alternatively, the processor 610 of FIG. 19 may be identical to the processing chips 114 and 124 of FIG. 1.

A memory 620 of FIG. 19 may be identical to the memories 112 and 122 of FIG. 1. Alternatively, the memory 620 of FIG. 19 may be a separate external memory different from the memories 112 and 122 of FIG. 1.

Referring to FIG. 19, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 19, a speaker 640 may output a result related to a sound processed by the processor 610. A microphone 641 may receive an input related to a sound to be used by the processor 610.

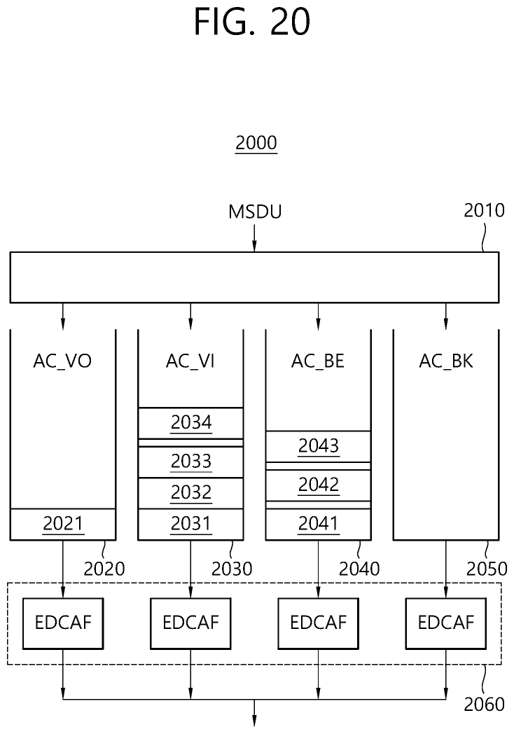

FIG. 20 is a diagram illustrating a channel access method based on EDCA. In a wireless LAN system, an STA may perform a channel access according to a plurality of user priorities defined for an enhanced distributed channel access (EDCA).

Particularly, for a transmission of quality of service (QoS) data frame based on a plurality of user priorities, four access categories ((AC) (AC_BK (background), AC_BE (best effort), AC_VI (video), and AC_VO (voice)) may be defined.

The STA may receive traffic data (e.g., MAC service data unit (MSDU)) having a preconfigured user priority from a higher layer.

For example, in order to determine a transmission order of a MAC frame to be transmitted by the STA, a differential value may be set to each traffic data in the user priority. The user priority may be mapped to each access category (AC) to which traffic data is buffered in the scheme as represented in Table 5 below.

TABLE 5

| Priority | User priority | AC (access category) |
|---|---|---|
| low | 1 | AC_BK |
| | 2 | AC_BK |
| | 0 | AC_BE |
| | 3 | AC_BE |
| | 4 | AC_VI |
| | 5 | AC_VI |
| | 6 | AC_VO |
| high | 7 | AC_VO |

In the present disclosure, the user priority may be understood as a traffic identifier (hereinafter, ‘TID’) that represents a property of data traffic.

Referring to Table 5, the traffic data of which user priority (i.e., TID) is ‘1’ or ‘2’ may be buffered to a transmission queue 2050 of AC_BK type. The traffic data of which user priority (i.e., TID) is ‘0’ or ‘3’ may be buffered to a transmission queue 2040 of AC_BE type.

The traffic data of which user priority (i.e., TID) is ‘4’ or ‘5’ may be buffered to a transmission queue 2030 of AC_VI type. The traffic data of which user priority (i.e., TID) 15 ‘6’ or ‘7’ may be buffered to a transmission queue 2020 of AC_VO type.

Instead of DCF interframe space (DIFS), CWmin, and CWmax, which are parameters for the backoff operation/procedure based on the conventional distributed coordination function (DCF), EDCA parameter set, arbitration interframe space (AIFS) [AC], CWmin [AC], CWmax [AC], and TXOP limit [AC] may be used for backoff operation/procedure of an STA that performs EDCA.

Based on the differentiated EDCA parameter set, a difference of transmission priority between ACs may be implemented. A default value of the EDCA parameter set (i.e., AIFS[AC], CWmin [AC], CWmax [AC], and TXOP limit [AC]) that corresponds to each AC is exemplified as represented in Table 6 below.

TABLE 6

| AC | CWmin[AC] | CWmax[AC] | AIFS[AC] | TXOP limit[AC] |
|---|---|---|---|---|
| AC_BK | 31 | 1023 | 7 | 0 |
| AC_BE | 31 | 1023 | 3 | 0 |
| AC_VI | 15 | 31 | 2 | 3.008 ms |
| AC_VO | 7 | 15 | 2 | 1.504 ms |

The EDCA parameter set for each AC may be set to a default value or may be included in a beacon frame and transferred to each STA from an access point (AP). The EDCA parameter set has higher priority as values of AIFS [AC] and CWmin [AC] become smaller, and accordingly, a channel access delay is shortened, and more bands may be used in a given traffic environment.

The EDCA parameter set may include information for a channel access parameter (e.g., AIFS [AC], CWmin [AC], and CWmax [AC]) for each AC.

The backoff operation/procedure for EDCA may be performed based on the EDCA parameter set which is individually set to four ACs included in each STA. A proper configuration of an EDCA parameter value that defines different channel access parameters for each AC may optimize a network performance, and simultaneously, increase a transmission effect by a priority of traffic.

Therefore, an AP of a wireless LAN system needs to perform an overall management and adjustment function for the EDCA parameter to guarantee a fair medium access for all STAs that participate in a network.

Referring to FIG. 20, a single STA (or an AP 2000) may include a virtual mapper 2010, a plurality of transmission queues 2020 to 2050, and a virtual collision processor 2060. The virtual mapper 2010 shown in FIG. 20 may perform the role of mapping an MSDU received from a logical link control (LLC) layer to a transmission queue that corresponds to each AC.

The plurality of transmission queues 2020 to 2050 shown in FIG. 20 may perform the role of an individual EDCA contention entity for a wireless media access in a single STA (or an AP).

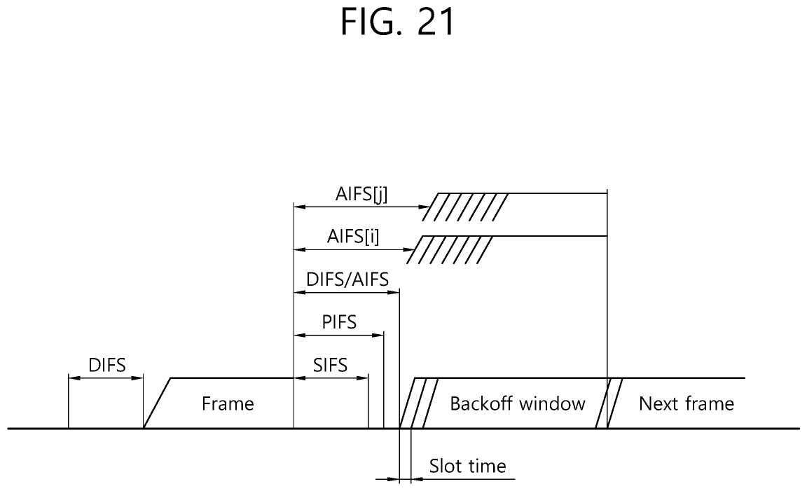

FIG. 21 is a conceptual diagram illustrating a backoff operation/procedure of EDCA.

A plurality of STAs may share a wireless medium based on DCF which is a contention based function. The DCF may use CSMA/CA for adjusting a collision between STAs.

According to the channel access technique, if a medium is not used during a DCF inter frame space (DIFS) (i.e., channel is idle), an STA may transmit an MPDU which is internally decided. The DIFS is a type of a time length used in IEEE standard, and IEEE standard uses various time durations such as SIFS (Short Inter-frame Space), PIFS (PCF Inter-frame Space), DIFS, and AIFS (arbitration interframe space). The specific value of each time duration may be configurable in various manners but may be configured as a length is elongated in an order of slot time, SIFS, PIFS, DIFS, and AIFS, generally.

In the case that a wireless medium is used by another STA by the carrier sensing mechanism (i.e., the channel is busy), the STA may determine a size of a contention window (hereinafter, “CW”) and perform the backoff operation/procedure.

In order to perform the backoff operation/procedure, each STA may set a backoff value which is randomly selected with a contention window (CW) to a backoff counter.

Each STA may perform a backoff procedure for channel access by counting down a backoff window in slot times. Among the plurality of STAs, an STA selecting the relatively shortest backoff window may obtain a transmission opportunity (hereinafter, “TXOP”) as the right to occupy a medium.

During the time duration for the TXOP, the remaining STAs may suspend the countdown operation. The remaining STAs may wait until the time period for the TXOP expires. After the time period for the TXOP expires, the remaining STAs may resume the suspended countdown operation to occupy the wireless medium.

According to such a transmission method based on the DCF, a collision phenomenon may be prevented, which may occur when a plurality of STAs simultaneously transmits a frame. However, the channel access technique using the DCF does not have a concept of a transmission priority (i.e., user priority). That is, using the DCF cannot guarantee the quality of service (QoS) of traffic to be transmitted by a STA.

In order to resolve this problem, a hybrid coordination function (hereinafter, “HCF”) as a new coordination function is defined in 802.11e. The newly defined HCF has more enhanced performance than the channel access performance of the legacy DCF. For enhancing QoS, the HCF may employ two different types of channel access methods, which are HCF-controlled channel access (HCCA) of a polling method and contention-based enhanced distributed channel access (EDCA).

Referring to FIG. 21, the STA assumes that the EDCA is performed for the transmission of traffic data buffered in the STA. Referring to Table 5, the user priority set to each traffic data may be differentiated to 8-step.

Each STA may include an output queue of four types (AC_BK, AC_BE, AC_VI, and AC_VO) which are mapped to the user priority of 8-step.

The ISF such as SIFS, PIFS, and DIFS is additionally described as below.

The ISF may be determined based on an attribute which is specified by a physical layer of an STA, regardless of a bit rate of the STA. Among the inter frame spacings (IFSs), the remainder other than the AIFS may use a preset value for each physical layer in a fixed manner.

The AIFS may be set to a value that corresponds to a transmission queue of four types which are mapped to the user priority as represented in Table 5.

The SIFS has the shortest time gap among the IFSs mentioned above. Accordingly, the SIFS may be used when an STA that occupies a wireless medium is required to maintain the occupation of the medium without any interruption by another STA during a period in which a frame exchange sequence is performed.

That is, the smallest gap between transmissions within a frame exchange sequence is used, and a priority may be provided for which a frame exchange sequence in progress is completed. Furthermore, the STA that accesses the wireless medium by using the SIFS may immediately start a transmission from the SIFS boundary without determining whether the medium is busy.

The SIFS duration for a specific physical (PHY) layer may be defined based on a SIFSTime parameter. For example, the SIFS value is 16 μs in physical (PHY) layers according to IEEE 802.11a, IEEE 802.11g, IEEE 802.11n, and IEEE 802.11ac standards.

The PIFS may be used to provide an STA the next highest priority level after the SIFS to the STA. That is, the PIFS may be used to obtain a priority to access the wireless medium.

The DIFS may be used by an STA that transmits a data frame (MPDU) and a management frame (Mac Protocol Data Unit; MPDU) based on the DCF. After a received frame and a backoff time expire, in the case that the medium is determined to be idle by a carrier sense (CS) mechanism, the STA may transmit a frame.

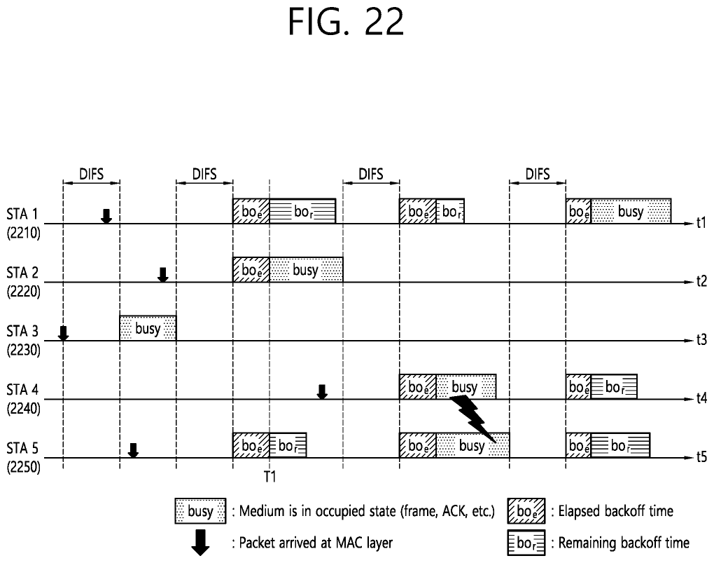

FIG. 22 is a diagram illustrating a backoff operation.

Each of STAs 2210, 2220, 2230, 2240, and 2250 may select a backoff value for the backoff operation/procedure individually. And then, each of the STAs may attempt to perform transmission after waiting for time expressing the selected backoff value in slot time (i.e., the backoff window). Further, each of the STAs may count down the backoff window by slot time. The countdown operation for channel access for a wireless medium may be individually performed by each STA.

A time corresponding to the backoff window may be referred to as a random backoff time (Tb[i]). In other words, each STA may individually set a backoff time (Tb[i]) in a random backoff counter for each STA.

Specifically, the random backoff time (Tb[i]) corresponds to a pseudo-random integer value and may be calculated by Equation 1 below.

Tb[i]=Random(i)*SlotTime [Equation 1]

Random(i) in Equation 1 denotes a function using uniform distribution and generating a random integer between 0 and CW[i]. CW[i] may be construed as a contention window that is selected between a minimum contention window (CWmin[i]) and a maximum contention window (CWmax[i]). The minimum contention window (CWmin[i]) and the maximum contention window (CWmax[i]) may correspond to CWmin[AC] and CWmax[AC], which are default values in Table 6.

In initial channel access, the STA may select a random integer between 0 and CWmin[i], with CW[i] set to CWmin[i]. In this embodiment, the selected random integer may be referred to as a backoff value.

i may be understood as the user priority level of traffic data. That is, i in Equation 1 may be understood as corresponding to any one of AC_VO, AC_VI, AC_BE, and AC_BK in Table 5.

SlotTime in Equation 1 may be used to provide sufficient time for a preamble of the transmitting STA to be fully detected by a neighboring STA. SlotTime in Equation 1 may be used to define the PIFS and the DIFS mentioned above. For example, SlotTime may be 9 μs.

For example, when the user priority level (i) is 7, an initial backoff time (Tb [AC_V0]) for a transmission queue of the AC_VO type may be a time expressing a backoff value, which is selected between 0 and CWmin[AC_VO], in a slot time.

When a collision occurs between STAs according to the backoff procedure (or when an ACK frame of a transmitted frame is not received), the STA may calculate increased backoff time (Tb[i]′) by Equation 2 below.

CWnew[i]=((CWold[i]+1)*PF)−1 [Equation 2]

Referring to Equation 2, a new contention window (CWnew[i]) may be calculated based on a previous contention window (CWold[i]). PF in Equation 2 may be calculated in accordance with a procedure defined in IEEE 802.11e. For example, PF in Equation 2 may be set to 2.

In this embodiment, the increased backoff time (Tb[i]′) may be construed as time expressing a random integer (i.e., backoff value), which is selected between 0 and the new contention window (CWnew[i]), in slot time.

CWmin[i], CWmax[i], AIFS[i], and PF values mentioned in FIG. 22 may be signaled from an AP through a QoS parameter set element, which is a management frame. The CWmin[i], CWmax[i], AIFS[i], and PF values may be values preset by the AP and the STA.

Referring to FIG. 22, if a particular medium is changed from an occupied or busy state to an idle state, the plurality of STAs may attempt to transmit data (or a frame). In this case, to minimize a collision between STAs, each STA may select backoff time (Tb[i]) according to Equation 1 and may attempt transmission after waiting for slot time corresponding to the selected backoff time.

When a backoff operation/procedure is initiated, each STA may count down an individually selected backoff counter time by slot times. Each STA may continuously monitor the medium while performing the countdown.

When the wireless medium is determined to be occupied, the STAs may suspend the countdown and may wait. When the wireless medium is determined to be idle, the STAs may resume the countdown.

Referring to FIG. 22, when a frame for the third STA 2230 reaches the MAC layer of the third STA 2230, the third STA 2230 may determine whether the medium is idle during a DIFS. When it is determined that the medium is idle during the DIFS, the third STA 2230 may transmit the frame.

While the frame is transmitted from the third STA 2230, the remaining STAs may check the occupancy state of the medium and may wait for the transmission period of the frame. A frame may reach the MAC layer of each of the first STA 2210, the second STA 2220, and the fifth STA 2250. When it is determined that the medium is idle, each STA may wait for the DIFS and may then count down backoff time individually selected by each STA.

FIG. 22 shows that the second STA 2220 selects the shortest backoff time and the first STA 2210 selects the longest backoff time. FIG. 22 shows that the remaining backoff time for the fifth STA 2250 is shorter than the remaining backoff time for the first STA 2210 at the time (T1) when a backoff operation/procedure for the backoff time selected by the second STA 2220 is completed and the transmission of a frame starts.

When the medium is occupied by the second STA 2220, the first STA 2210 and the fifth STA 2250 may suspend the backoff operation/procedure and may wait. When the second STA 2220 finishes occupying the medium (i.e., when the medium returns to be idle), the first STA 2210 and the fifth STA 2250 may wait for the DIFS.

Subsequently, the first STA 2210 and the fifth STA 2250 may resume the backoff procedure based on the suspended remaining backoff time. In this case, since the remaining backoff time for the fifth STA 2250 is shorter than the remaining backoff time for the first STA 2210, the fifth STA 2250 may complete the backoff procedure before the first STA 2210.

Meanwhile, referring to FIG. 22, when the medium is occupied by the second STA 2220, a frame for the fourth STA 2240 may reach the MAC layer of the fourth STA 2240. When the medium is idle, the fourth STA 2240 may wait for the DIFS. Subsequently, the fourth STA 2240 may count down the backoff time selected by the fourth STA 2240.

Referring to FIG. 22, the remaining backoff time for the fifth STA 2250 may coincidently match the remaining backoff time for the fourth STA 2240. In this case, a collision may occur between the fourth STA 2240 and the fifth STA 2250. If the collision occurs between the STAs, both the fourth STA 2240 and the fifth STA 2250 may not receive an ACK and may fail to transmit data.

Accordingly, the fourth STA 2240 and the fifth STA 2250 may individually calculate a new contention window (CWnew[i]) according to Equation 2. Subsequently, the fourth STA 2240 and the fifth STA 2250 may individually count down backoff time newly calculated according to Equation 2.

Meanwhile, when then medium is occupied state due to transmission by the fourth STA 2240 and the fifth STA 2250, the first STA 2210 may wait. Subsequently, when the medium is idle, the first STA 2210 may wait for the DIFS and may then resume backoff counting. After the remaining backoff time for the first STA 2210 elapses, the first STA 2210 may transmit a frame.

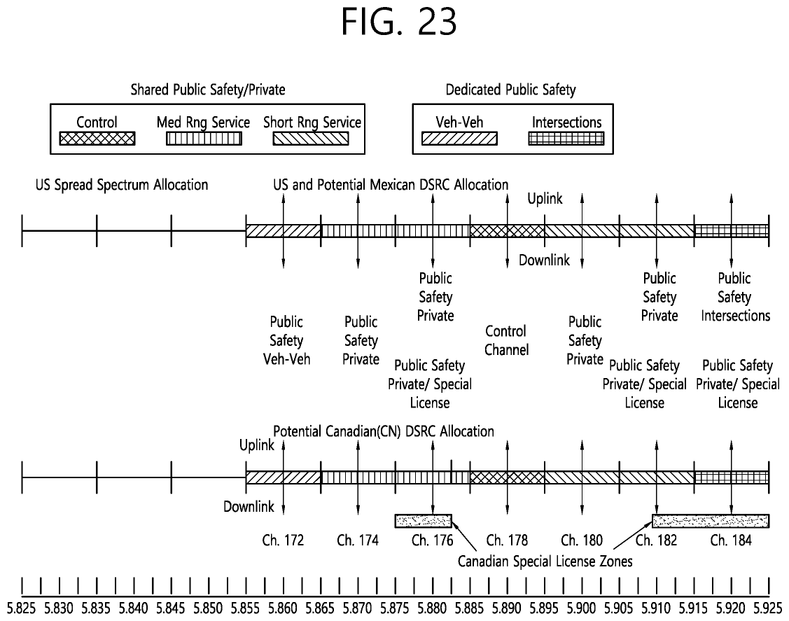

FIG. 23 illustrates a band plan of 5.9 GHz DSRC.

5.9 GHz DSRC is a communication service in a range from a short distance to a middle distance which supports the communication environment for all the vehicle on the roadside and between vehicles, the public safety, and the unpublished task. The DSRC provides very high data transmission speed in a situation in which a waiting time of a communication link is minimized, and division of a small communication range is important, and accordingly, supplements the cellular communication. In addition, PHY and MAC protocols are based on IEEE 802.11p revision for a radio access in a vehicle environment (WAVE).

<IEEE 802.11p>

802.11p standard uses the PHY of 802.11a standard by 2× down clocking. That is, a signal is transmitted by using 10 MHz bandwidth, not 20 MHz bandwidth. The numerology in which 802.11a and 802.11p are compared is as below.

TABLE 7

| | IEEE 802.11a | IEEE 802.11p |
|---|---|---|
| Symbol duration | 4 us | 8 us |
| Guard period | 0.8 us | 1.6 us |
| Subcarrier spacing | 312.5 KHz | 156.25 KHz |
| OFDM subcarrier | 52 | 52 |
| Number of pilot | 4 | 4 |
| Default BW | 20 MHz | 10 MHz |
| Data rate (Mbps) | 6, 9, 12, 18, 24, 36, 48, | 3, 4.5, 6, 9, 12, 18, 24, |
| | 54 Mbps | 27 Mbps |
| Frequency band | 5 GHz ISM | 5.9 GHz dedicated |

The DSRC band includes a control channel and a service channel, and data transmissions of 3, 4.5, 6, 9, 12, 18, 24, and 27 Mbps are available through each of the channels. In the case that the DSRC band includes an optional channel of 20 MHz, transmissions of 6, 9, 12, 18, 24, 36, 48, and 54 Mbps are available. Transmissions of 6, 9, 12 Mbps need to be supported for all services and channels. In the case of the control channel, a preamble has 3 Mbps, but a message itself has 6 Mbps. Channels 174 and 176 and channels 180 and 182 become channels 175 and 181 of 20 MHz, respectively, in the case that the channels are approved by a frequency regulation organization. The remainder is left for future use. Through the control channel, a short message, an alarm data, and a public safety warning data are broadcasted to all OBUs (On Board Units). The reason for separation of the control from the service channel is for efficiency, and to maximize a service quality and to reduce interference between service.

Channel 178 is the control channel, and all OBUs automatically search the control channel and receive an alarm, a data transmission, and a warning message from an RSU (Road Side Unit). All data of the control channel need to be transmitted within 200 ms and are repeated in a predefined period. In the control channel, the public safety data is prior to all private messages. The private message greater than 200 ms is transmitted through the service channel.

Through the service channel, a private message or a long public safety message is transmitted. To prevent a collision, the technique of detecting a channel state before a transmission (Carrier Sense Multiple Access: CSMA) is used.

Next, an EDCA parameter in OCB (Outside Context of BSS) mode is defined. The OCB mode means a state in which an inter-node direct communication is available without a process of being associated with an AP. The following table represents a set of basic EDCA parameters for an STA operation in the case that dot11OCBActivated is true.

TABLE 8

| AC | CWmin | CWmax | AIFSN | TXOP limit |
|---|---|---|---|---|
| AC_BK | aCWmin | aCWmax | 9 | 0 |
| AC_BE | aCWmin | aCWmax | 6 | 0 |
| AC_VI | (aCWmin + 1)/2 − 1 | aCWmin | 3 | 0 |
| AC_VO | (aCWmin + 1)/4 − 1 | (aCWmin + 1)/2 − 1 | 2 | 0 |

The characteristics of the OCB mode are as below.

In a MAC header, To/From DS fields=0

Address
Individual or a group destination MAC address
BSSID field=wildcard BSSID
Data/Management frame=>Address 1: RA, Address 2: TA, Address 3: wildcard BSSID

Not utilize IEEE 802.11 authentication, association, or data confidentiality services

TXOP limit=0

Only TC(TID) is used.

An STA is not required to synchronize to a common clock or to use these mechanisms.
STAs may maintain a TSF timer for purposes other than synchronization.

The STA may send Action frames and, if the STA maintains a TSF Timer, Timing Advertisement frames.

The STA may send Control frames, except those of subtype PS-Poll, CF-End, and CF-End+CFAck.

The STA may send Data frames of subtype Data, Null, QoS Data, and QoS Null.

An STA with dot11OCBActivated equal to true shall not join or start a BSS.

Hereinafter, proposed is a method for providing interoperability between the system (802.11bd standard) proposed to improve throughput and support a high speed for V2X (Vehicle-to-Everything) in 5.9 GHz band and the DSRC system based on the conventional IEEE 802.11p.

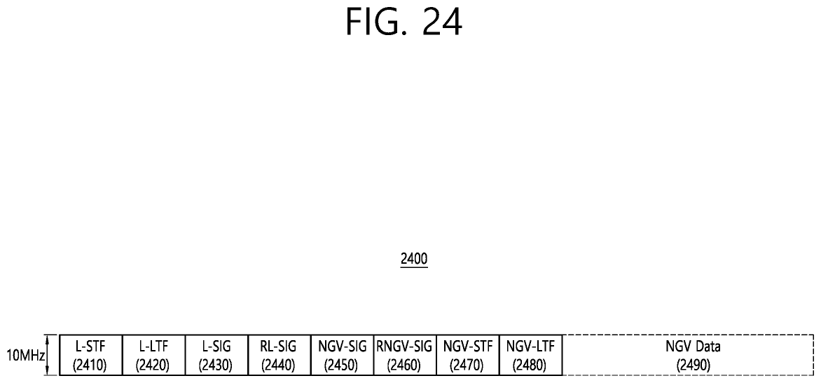

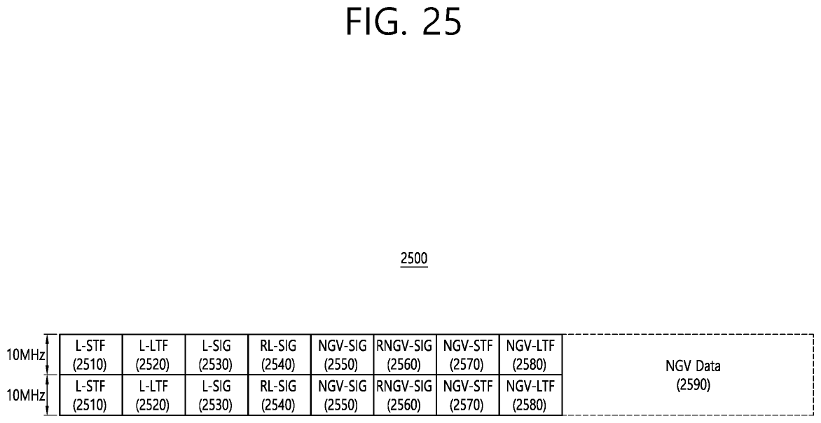

In 5.9 GHz band, a technique for NGV has been developed, which considers throughput improvement and high speed support of the DSCR for smooth V2X support. FIGS. 24 and 25 illustrate the frame (hereinafter, 11bd frame) format according to 802.11bd standard.

FIG. 24 illustrates the frame format according to 802.11bd standard.

Referring to FIG. 24, a 11bd frame 2400 may be configured with 10 MHz. For backward compatibility or interoperability with 802.11p standard, the 11bd frame may include a preamble part of a 11p frame. For example, the 11bd frame 2400 may include an L-STF 2410, an L-LTF 2420, or an L-SIG (or L-SIG field) 2430. Additionally, the 11bd frame may include an RL-SIG (or RL-SIG field) 2440, an NGV-SIG (or NGV-SIG field) 2450, an RNGV-SIG (or RNGV-SIG field) 2460, an NGV-STF 2470, an NGV-LTF 2480, or an NGV Data (or NGV-Data field) 2490.

The RL-SIG 2440 may be positioned after the L-SIG 2430. The RL-SIG 2440 may be a field in which the L-SIGs 2430 are repeated. The RL-SIG 2440 may be modulated in the same way of the L-SIG 2430.

The NGV-SIG 2450 may be in relation to transmission information. For example, the NGV-SIG 2450 may include the transmission information. For example, the NGV-SIG 2450 may include information for bandwidth, MCS, Nss, Midamble periodicity, LDPC Extra symbol, LTF format, or tail bit. The BCC encoding based on ½ coding rate may be applied to the NGV-SIG 2450.

The RNGV-SIG 2460 may be a field in which the NGV-SIGs 2450 are repeated. The RNGV-SIG 2460 may be modulated in the same way of the NGV-SIG 2450.

The NGV-STF 2470 may be constructed by 2× downclocking of the 20 MHz VHT-STF according to 802.11ac standard. The NGV-LTF 2480 may be constructed by 2× downclocking of the 20 MHz VHT-LTF according to 802.11ac standard.

FIG. 25 illustrates another format of the frame according to 802.11bd standard.

Referring to FIG. 25, a 11bd frame 2500 may be configured with 10 MHz. The 11bd frame 2500 may include an L-STF 2510, an L-LTF 2520, an L-SIG 2530, an RL-SIG 2540, an NGV-SIG 2550, an RNGV-SIG 2560, an NGV-STF 2570, an NGV-LTF 2580, or an NGV Data 2590.

The L-STF 2510, the L-LTF 2520, or the L-SIG 2530 may be constructed by being duplicated in a unit of 10 MHz. According to an embodiment, the RL-SIG 2540, the NGV-SIG 2550, or the RNGV-SIG 2560 may also be constructed by being duplicated in a unit of 10 MHz.

The NGV-STF 2570 may be constructed by 2× downclocking of the 40 MHz VHT-STF according to 802.11ac standard. The NGV-LTF 2580 may be constructed by 2× downclocking of the 40 MHz VHT-LTF according to 802.11ac standard.

An example of the present disclosure is in relation to the 11bd frame (or 11bd PPDU). The 11bd frame may be used in various wireless communication systems, for example, may be used in the IEEE 802.11bd wireless LAN system.

The 11bd frame may be referred to using various terms. For example, the 11bd frame may be called an NGV frame, an NGV PPDU, an 11bd PPDU, and the like. In addition, in another example, the 11bd frame may be referred to as various terms such as a first type PPDU, a transmission PPDU, a reception PPDU, a wireless LAN PPDU, and the like. Hereinafter, for the convenience of description, the 11bd frame may be called the NGV PPDU. In addition, a PPDU according to 802.11p standard may be called an 11p PPDU.

Similarly, an STA supporting 802.11bd standard may be referred to various terms. For example, the STA supporting 802.11bd standard may be called an 11bd STA, an NGV STA, a transmission STA, or a reception STA. Hereinafter, for the convenience of description, the STA supporting 802.11bd standard may be called the NGV STA. In addition, the STA supporting 802.11p standard may be called an 11p STA.

Furthermore, 5.9 GHz band may be represented in various ways such as an NGV band, a reception band, a transmission band.

According to the Next generation V2X communication (e.g., NGV or 802.11bd standard), a 20 MHz transmission may be supported. For example, an apparatus according to 802.11bd standard (hereinafter, NGV STA) may transmit an NGV-PPDU constructed with 20 MHz bandwidth. That is, an NGV-PPDU may be transmitted with 20 MHz bandwidth. Accordingly, an efficient channel access method for the 20 MHz transmission may be requested. Hereinafter, the present disclosure may propose a method for performing a channel access based on a channel which is commonly used by an NGV STA in the 20 MHz transmission.

Hereinafter, an anchor channel may be defined. The anchor channel may mean a channel through which all NGV STAs commonly operate (e.g., channel access, reception). The anchor channel may be expressed in various terms. For example, the anchor channel may be called a primary channel or a first channel. According to an embodiment, the anchor channel may be regulated in an upper layer. The NGV STA may obtain information for the anchor channel through the upper layer.

The NGV STA may perform a channel access based on whether the anchor channel is present and a bandwidth when performing the 20 MHz transmission. Hereinafter, various methods for the NGV STA to perform a channel access may be proposed.

1. 20 MHz Anchor Channel

1-A. The NGV STA may perform CCA/EDCA (Clear Channel Assessment/Enhanced Distributed Channel Access) for the entire 20 MHz channel. 20 MHz channel may include a first channel set to 10 MHz and a second channel set to 10 MHz. For example, the NGV STA may maintain a single BC (Backoff Count) value for the entire 20 MHz channel (i.e., the first channel and the second channel). Subsequently, the NGV STA may transmit an NGV PPDU of 20 MHz or an NGV PPDU (or 11p PPDU) of 10 MHz. The BC value mentioned above may be expressed as various terms. For example, the BC value may be referred to as a backoff count, a backoff counter, and/or a BC.

According to an embodiment, when the NGV STA performs the CCA/EDCA for the entire 20 MHz channel, the NGV STA may consider/identify the entire 20 MHz channel state. In other words, the NGV STA may perform the CCA/EDCA for the entire 20 MHz band based on the entire 20 MHz channel state. According to an embodiment, when the NGV STA performs the CCA/EDCA for the entire 20 MHz channel, the NGV STA may consider each 10 MHz channel state. In other words, the NGV STA may perform the CCA/EDCA for the entire 20 MHz channel based on each 10 MHz channel state.

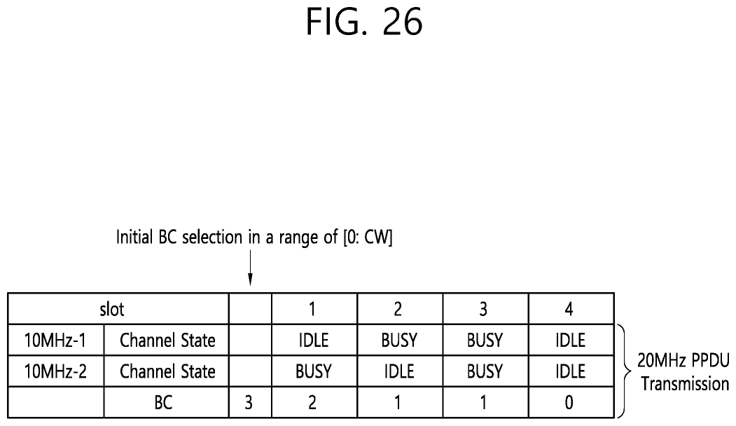

In the first embodiment, the NGV STA may consider/identify each 10 MHz channel state. In other words, the NGV STA may determine a channel state of the first channel and a channel state of the second channel. In the case that at least one 10 MHz channel is idle (or in an idle state), the NGV STA may decrease the BC. In other words, the NGV STA may decrease the BC value based on the condition that at least one 10 MHz channel is idle. That is, the NGV STA may decrease the BC value based on the condition that at least one channel of the first channel and the second channel is idle. The first embodiment may be described again with reference to FIG. 26.

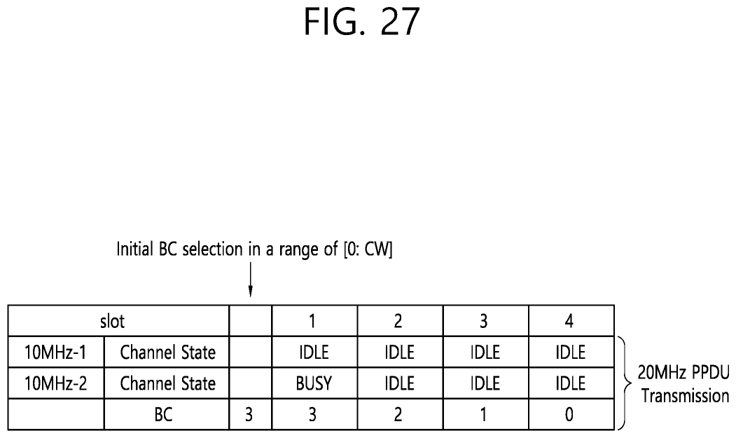

In the second embodiment, the NGV STA may consider each 10 MHz channel state. In the case that all 10 MHz channels are idle (or in an idle state), the NGV STA may decrease the BC. In other words, the NGV STA may decrease the BC based on the condition that all 10 MHz channels are idle. That is, the NGV STA may decrease the BC value based on the condition that both the first channel and the second channel are idle. The second embodiment may be described again with reference to FIG. 27.

According to the first embodiment and the second embodiment, the NGV STA may transmit an NGV PPDU to an idle channel when the BC value of the entire 20 MHz band is a first value (e.g., {0}). In other words, the NGV STA may transmit a PPDU (e.g., NGV PPDU) to an idle channel based on the condition that the BC value of the entire 20 MHz channel is the first value (e.g., {0}).

According to an embodiment, in the case that the NGV STA performs a channel sensing of each 10 MHz channel, the NGV STA may perform a channel sensing of one 10 MHz channel by a Preamble Detection (PD). In addition, the NGV STA may perform a channel sensing of another 10 MHz channel by an Energy Detection (ED) or a Guard Interval (GI) detection. That is, the NGV STA may perform a channel sensing in the first channel by the PD and may perform a channel sensing in the second channel by the ED. However, the method for the NGV STA to perform a channel sensing is not limited thereto.

According to an embodiment, the NGV STA may perform a channel sensing by the PD in both two 10 MHz channels. In addition, for the channel sensing interval of each 10 MHz channel, AIFS[AC] may be used in accordance with each AC, like the conventional standard. However, the embodiment is not limited thereto. In one example, for the channel sensing interval of 10 MHz channel, PIFS or EIFS (Extended interframe space) may be used.

According to an embodiment, without regard to the detection method described above, each 10 MHz sensitivity threshold (or the minimum modulation and coding rate sensitivity) may be set to −85 dBm or lower in both two 10 MHz channels for fairness.

According to an embodiment, like the conventional standard, in the 10 MHz channel to which the PD is applied, a threshold (or 10 MHz sensitivity threshold) may be set to −85 dBm or lower. In addition, in another 10 MHz channel, a threshold (or 10 MHz sensitivity threshold) may be set to −75 dBm or a value between −75 dBm and −85 dBm (e.g., −79 dBm or −82 dBm, etc.).

According to an embodiment, an Energy Detection threshold (or 10 MHz sensitivity threshold) may be set to −85 dBm for fairness. In addition, an Energy Detection threshold may be set to −65 dBm or a value between −65 dBm and −85 dBm (e.g., −82 dBm or −75 dBm, etc.) for priority.

According to the first embodiment, when the BC is the first value (e.g., {0}), in the case that all 10 MHz channel are idle, the NGV STA may transmit a 20 MHz PPDU (e.g., 20 MHz NGV PPDU). In addition, when the BC is the first value (e.g., {0}), in the case that only one 10 MHz channel is idle, the NGV STA may transmit a 10 MHz PPDU (e.g., 10 MHz NGV PPDU) to the idle channel. In other words, the NGV STA may transmit one of the 10 MHz PPDU or the 20 MHz PPDU based on whether the BC is the first value (e.g., {0}).

According to the second embodiment, when the BC is the first value (e.g., {0}), there is no case in which only one 10 MHz channel is idle for the NGV STA. Accordingly, when the BC is the first value (e.g., {0}), the NGV STA may not transmit a PPDU (e.g., NGV PPDU) even in the case that only one 10 MHz channel is idle.

According to the first embodiment, in comparison with the second embodiment, there is an effect that a PPDU may be transmitted fast in a congested channel environment. However, according to the first embodiment, the probability that a 20 MHz PPDU (e.g., 20 MHz NGV PPDU) is transmitted may be low.

According to the second embodiment, since all 10 MHz channels constructing 20 MHz channel are idle, latency may be longer than that of the first embodiment. However, according to the second embodiment, there is an effect that a 20 MHz PPDU may be transmitted for all times.

The first embodiment may be beneficially operating in the environment in which there are only STAs that transmit a NGV PPDU neighboring the NGV STA or the environment in which each 10 MHz transmission does not influence each other (e.g., 2 RFs with simultaneous DL/UL). In other words, the first embodiment may be efficiently operating in the environment in which there are only STAs that transmit a NGV PPDU neighboring the NGV STA or the environment in which each 10 MHz transmission does not influence each other (e.g., 2 RFs with simultaneous DL/UL).

However, the first embodiment may not satisfy coexistence in the environment in which there are not only STAs that transmit a NGV PPDU neighboring the NGV STA or the environment in which each 10 MHz transmission influences each other. For example, in the case that a 11p STA or another NGV STA transmits a 11p PPDU, the NGV STA may receive the 11p PPDU in 10 MHz channel with different timing. In this case, the NGV STA may not receive the 11p PPDU properly. Therefore, the first embodiment may not satisfy coexistence.

FIG. 26 is a diagram for describing an operation of the NGV STA.

Referring to FIG. 26, the NGV STA may operate based on the first embodiment described above. In this example, to show a simple process, the CCA during the IFS after busy may be omitted. This example may show only the process of decreasing a backoff count.

The 20 MHz channel may include the first channel set to 10 MHz and the second channel set to 10 MHz. The backoff count value may be set to one backoff count value in relation to the first channel and the second channel. For example, the backoff count value of the first channel and the second channel may be set to 3.

When at least one channel of the first channel and the second channel is idle, the backoff count value may be decreased. In other words, the NGV STA may decrease the backoff count (BC) value based on the condition that at least one channel of the first channel and the second channel is idle.

For example, the NGV STA may decrease the BC value in slot 1 since the first channel is idle. The NGV STA may decrease the BC value in slot 2 since the second channel is idle. The NGV STA may not decrease the BC value in slot 3 since both the first channel and the second channel are busy. The NGV STA may decrease the BC value in slot 4 since both the first channel and the second channel are idle. In slot 4, the BC value may be set to a first value (e.g., {0}). In addition, in slot 4, since both the first channel and the second channel are idle, the NGV STA may transmit a 20 MHz PPDU (e.g., 20 MHz NGV PPDU).

FIG. 27 is another diagram for describing an operation of the NGV STA.

Referring to FIG. 27, the NGV STA may operate based on the second embodiment described above. In this example, to show a simple process, the CCA during the IFS after busy may be omitted. This example may show only the process of decreasing a backoff count.

The 20 MHz channel may include the first channel set to 10 MHz and the second channel set to 10 MHz. The backoff count value may be set to one backoff count value in relation to the first channel and the second channel. For example, the backoff count value of the first channel and the second channel may be set to 3.

When both the first channel and the second channel are idle, the backoff count value may be decreased. In other words, the NGV STA may decrease the backoff count (BC) value based on the condition that both the first channel and the second channel are idle.

For example, the NGV STA may decrease the BC value in slot 2 and slot 3 since the first channel and the second channel are idle. In addition, in slot 4, the NGV STA may decrease the BC value since the first channel and the second channel are idle. In slot 4, the BC value may be set to a first value (e.g., {0}). In addition, in slot 4, since the BC value is set to a first value (e.g., {0}), the NGV STA may transmit a 20 MHz PPDU (e.g., 20 MHz NGV PPDU).

1-B. The NGV STA may perform CCA/EDCA for each 10 MHz channel. For example, the NGV STA may maintain a BC (Backoff Count) value for each 10 MHz channel. In other words, the NGV STA may perform the CCA/EDCA in the first channel, and in the same way, may perform the CCA/EDCA in the second channel. Accordingly, the BC value of the first channel may be differently set from the BC value of the second channel. Subsequently, the NGV STA may transmit an NGV PPDU of 20 MHz or an NGV PPDU (or 11p PPDU) of 10 MHz.

In the third embodiment, the NGV PPDU of 20 MHz may be transmitted in the case that the BC value of each 10 MHz channel is set to the first value simultaneously. In other words, the NGV STA may transmit an NGV PPDU of 20 MHz based on the condition that the BC value of each 10 MHz channel is the first value.

In the fourth embodiment, when a BC value of one 10 MHz channel becomes the first value, in the case that another 10 MHz channel is idle in a designated time period, the NGV STA may transmit an NGV PPDU of 20 MHz. In other words, the NGV STA may transmit an NGV PPDU of 20 MHz based on the condition that the BC value of first channel of 10 MHz is the first value, and the second channel of 10 MHz channel is idle in a designated time period.

According to the fourth embodiment, in the case that the BC value of the first channel is the first value, the BC value of the second channel may be set to the first value, even in the case that the BC value of the second channel is not the first value. For example, in the case that the BC value of the first channel is {0}, the NGV STA may set the BC value of the second channel to {0} even in the case that the BC value of the second channel is not {0}. According to an embodiment, the NGV STA may maintain the BC value of the second channel, may not change the BC value to the first value.

According to an embodiment, the designated time period described above may be set in various ways. The designated time period Td may be set as represented in Equation 3.

Td=xIFS (Interframe space)+N slots [Equation 3]

Referring to Equation 3, xIFS may be set to the SIFS, the PIF S, or the AIFS (including DIFS). N may be set to an integer of 1 or greater.

For example, xIFS may be set to the SIFS representatively. Based on the N value, the time period used in the conventional Wi-Fi system or 802.11p standard may be represented. The example therefor is described below.

i) For N=1, PIFS

ii) For N=2, DIFS (or AIFS[AC_VO/VI]) in 11p and 11n/ac/ax

iii) For N=3, AIFS[AC_BE] in 11n/ac/ax

iv) For N=4, AIFS[AC_VI] in 11p

v) For N=6, AIFS[AC_BE] in 11p

vi) For N=7, AIFS[AC_BK] in 11n/ac/ax

vii) For N=9, AIFS{AC_BK} in 11p

According to an embodiment, the value described above may be fixedly used, but the AIFS [AC] may be used, which was used in a 10 MHz channel of which BC value is the first value (e.g., {0}). That is, the BC is the AIFS, but the designated time period may be flexibly configured depending on the AC of traffic which is transmitted.

According to an embodiment, the BC value may be set to a value smaller than the AIFS used in a 11p STA or an NGV STA of which spacing for identifying a channel state of a 10 MHz channel (i.e., the second channel) is different, not the first value (e.g., {0}). In this case, the fairness for the 11p STA or the NGV STA that uses the 10 MHz channel may be degraded.

For example, in the case that the designated time period is set to the PIFS (i.e., N=1), there is an effect that the priority for a 20 MHz NGV PPDU is increased. However, since the designated time period is smaller than the AIFS, unfairness for a channel access may occur between the 11p STA or the NGV STA that uses the 10 MHz channel and the NGV STA that uses 20 MHz channel. Therefore, in the case that the designated time period is set to the AIFS, there is an effect that fairness may be more improved than the case that the designated time period is set to the PIFS.

According to the third embodiment, the conventional EDCA method for a 10 MHz channel may be maintained. However, since the probability that both the BC values of two channels become the first value (e.g., {0}) is low, a transmission chance for the 20 MHz PPDU may be reduced. According to the fourth embodiment, there is an effect that a transmission chance for the 20 MHz PPDU may be increased in comparison with the third embodiment. However, according to the fourth embodiment, since the BC value (i.e., the BC value of the second channel) of a current time is disregarded, the collision probability may be increased. In other words, the 20 MHz PPDU is transmitted even in the case that the BC value is not the first value in one channel between two 10 MHz channels, and the collision probability may be increased.

According to an embodiment, the BC value may be set to a value smaller than the conventional AIFS which is the spacing for identifying a channel state of a 10 MHz channel (i.e., the second channel), not the first value (e.g., {0}). Accordingly, the fairness for the 11p STA that uses the second channel may be degraded.

According to an embodiment, the BC value may be set to the PIFS which is the spacing for identifying a channel state of a 10 MHz channel (i.e., the second channel), not the first value (e.g., {0}). Since the PIFS is smaller than the AIFS, unfairness for a channel access may occur between the 11p STA or the NGV STA. Therefore, in the case that the spacing for identifying a channel state is set to the AIFS, there is an effect that fairness may be more improved than the case that the spacing for identifying a channel state is set to the PIFS.

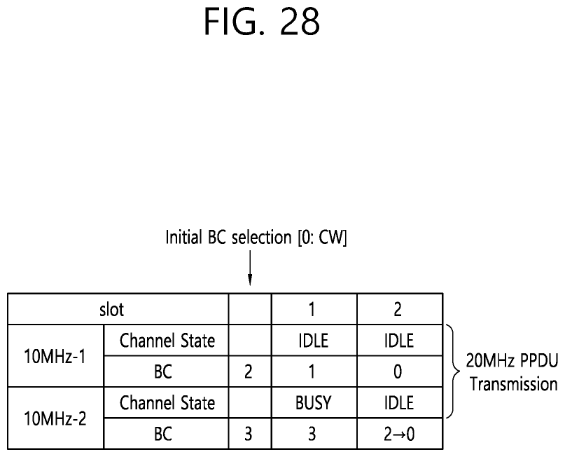

FIG. 28 is still another diagram for describing an operation of the NGV STA.

Referring to FIG. 28, the NGV STA may operate based on the fourth embodiment described above. In this example, to show a simple process, the CCA during the IFS after busy may be omitted. This example may show only the process of decreasing a backoff count.

The 20 MHz channel may include the first channel set to 10 MHz and the second channel set to 10 MHz. The backoff count value may be set to the BC value of the first channel and the BC value of the second channel, respectively. For example, the BC value of the first channel may be set to 2. The BC the second channel may be set to 3.

In slot 2, since the BC value of the first channel is the first value (e.g., {0}), although the BC value of the second channel is not the first value, the BC value of the second channel is set to the first value, and a 20 MHz PPDU may be transmitted. In other words, the NGV STA may set/change the BC value of the second channel to the first value based on the condition that the BC value of the first channel is the first value (e.g., {0}). The NGV STA may transmit a 20 MHz PPDU based on the condition that the BC values of the first channel and the second channel are set to the first value.

2. 10 MHz Anchor Channel

2-A. The CCA/EDCA May be Performed in the Anchor Channel.

In the fifth embodiment, in the case that the BC value of the anchor channel is the first value (e.g., {0}), the NGV STA may identify whether a 10 MHz channel (hereinafter, the second channel), not the anchor channel, is idle during a designated time period. In the case that the second channel is idle during a designated time period, the NGV STA may transmit a 20 MHz NGV PPDU. In the case that the second channel is idle during a designated time period, the NGV STA may transmit an NGV PPDU (or 11p PPDU) of 10 MHz unit. According to an embodiment, in the case that the second channel is idle during a designated time period, the NGV STA may not transmit an NGV PPDU (or 11p PPDU) of 10 MHz unit.

According to an embodiment, the designated time period may be configured as represented in Equation 4 below.

Td=xIFS (Interframe space)+N slots [Equation 4]

Referring to Equation 4, xIFS may be set to the SIFS, the PIFS, or the AIFS (including DIFS). N may be set to an integer of 1 or greater.

For example, xIFS may be set to the SIFS representatively. Based on the N value, the time period used in the conventional Wi-Fi system or 802.11p standard may be represented. The example therefor is described below.

i) For N=1, PIFS

ii) For N=2, DIFS (or AIFS[AC_VO/VI]) in 11p and 11n/ac/ax

iii) For N=3, AIFS[AC_BE] in 11n/ac/ax

iv) For N=4, AIFS[AC_VI] in 11p

v) For N=6, AIFS[AC_BE] in 11p

vi) For N=7, AIFS[AC_BK] in 11n/ac/ax

vii) For N=9, AIFS{AC_BK} in 11p

According to an embodiment, the value described above may be fixedly used, but the AIFS [AC] may be used, which was used in a 10 MHz channel of which BC value is the first value (e.g., {0}). That is, the BC is the AIFS, but the designated time period may be flexibly configured depending on the AC of traffic which is transmitted. In other words, the designated time period may be configured based on the AC of traffic which is transmitted.

The fifth embodiment described above may satisfy coexistence between the 11p STA that transmits a 11p PPDU and an NGV STA. In addition, the NGV STA may stably transmit a PPDU of 10 MHz or 20 MHz.

However, the spacing for identifying a channel state of a 10 MHz channel (i.e., the second channel), not the anchor channel, may be set to a value smaller than the AIFS used in another 11p STA or the NGV STA. In this case, the fairness for the 11p STA that uses the 10 MHz channel and the NGV STA may be degraded.

For example, in the case that the designated time period is set to the PIFS (i.e., N=1), there is an effect that the priority for a 20 MHz NGV PPDU is increased. However, since the designated time period is smaller than the AIFS, unfairness for a channel access may occur between the 11p STA that uses the 10 MHz channel and the NGV STA that uses the 20 MHz channel. Therefore, in the case that the designated time period is set to the AIFS, there is an effect that fairness may be more improved than the case that the designated time period is set to the PIFS.

According to an embodiment, the designated time period may be statically or adaptively configured.

For example, the designated time period may be statically configured. In this case, in Equation 4, a single N value may be configured/used.

For another example, the designated time period may be adaptively configured. Hereinafter, a method for the designated time period to be adaptively configured is described. In addition, hereinafter, an NGV mode may mean the state in which an NGV STA may transmit an NGV PPDU.

I. When an NGV STA is switched to the NGV mode, for a predetermined time (or timer), the N value may be set/used to 2, 3, or 7. In addition, when the predetermined time (or timer) expires, the N value may be set/used to 1 (i.e., PIFS).

I-A. According to an embodiment, on the timing when a 11p PPDU is not detected, the mode of the NGV STA may be switched to the NGV mode. According to an embodiment, a 11p PPDU is not detected for a predetermined time (or timer), and the mode of the NGV STA may be switched to the NGV mode on the timing when the predetermined time (or timer) expires.

II. When the mode of the NGV STA may be switched to the NGV mode, in the case that a 11p PPDU transmitted by the NGV STA is received, the N value may be set/used to 2, 3, or 7. In addition, in the case that a 11p PPDU is not received anymore, the N value may be set/used to 1.

II-A. According to an embodiment, on the timing when a 11p PPDU is not detected, the mode of the NGV STA may be switched to the NGV mode. According to an embodiment, a 11p PPDU is not detected for a predetermined time (or timer), and the mode of the NGV STA may be switched to the NGV mode on the timing when the predetermined time (or timer) expires.

In the case that the designated time period is statically or adaptively configured, for a longer time than the PIFS, the adaptive scheme may further degrade a priority for the NGV STA in comparison with the static scheme. However, the adaptive scheme has an effect of further enhancing the fairness for a 11p STA in comparison with the static scheme. In the adaptive scheme, the second scheme (section II described above) considers up to the case that a hidden node is a 11p STA, and accordingly, there is an effect of enhancing the fairness for a 11p STA.

According to an embodiment, a sensitivity threshold (or the minimum modulation and coding rate sensitivity) for a 10 MHz channel (hereinafter, the second channel), not the anchor channel, may be set to −85 dBm for the fairness for a 11p STA that uses the second channel or an NGV STA. That is, the sensitivity threshold for the second channel may be identically set to −85 dBm which is the sensitivity threshold set in the anchor channel.

According to an embodiment, like the conventional standard, the sensitivity threshold for a 10 MHz channel), not the anchor channel, may be set to −75 dBm or a value between −75 dBm and −85 dBm (e.g., −79 dBm or −82 dBm, etc.) for priority.

According to an embodiment, an Energy Detection threshold may be set to −85 dBm for fairness. According to an embodiment, an Energy Detection threshold may be set to −65 dBm for priority. According to an embodiment, an Energy Detection threshold may be set to a value between −65 dBm and −85 dBm (e.g., −82 dBm or −75 dBm, etc.) for priority.

TXOP Limit in NGV Mode

According to 802.11p standard, a TXOP limit is set to {0}. Therefore, according to 802.11p standard, a frame exchange occurs once in a single TXOP. According to an embodiment, in the case of the NGV standard (or NGV STA), even in the case of using a 11p PPDU, several frames may be allowed in a single TXOP. In this case, there is an effect that the performance may be improved. Accordingly, in the NGV mode, a TXOP limit may be set to {0} or a greater value.

Signaling Method for Anchor Channel

Different from the conventional standard, in the NGV standard, channel information may not be informed in a beacon. Accordingly, another method for informing information for the anchor channel may be requested. Hereinafter, a method for informing information for the anchor channel is described.

1) Parameters for Primitives (Layer Upper than PHY/MAC Layer)

In the conventional WAVE MAC (MAC layer), an MLME extension may exist, which performs a Multi-channel operation which is higher than the conventional MLME (MAC sublayer management entity).

As a first method, in the MLME extension SAP (service access point), SCH/CCH (service channel/control channel) information may be indicated through a Chanel identifier Parameter. Accordingly, through the Chanel identifier Parameter, information for the anchor channel may be additionally indicated. In other words, the Chanel identifier Parameter may include information for the anchor channel.

As a second method, in an SAP, a new parameter may be configured. The new parameter may include the information for the anchor channel.

The information for the anchor channel may include information for a Country String, information for an Operating Class, or information for a Channel number. The information for the anchor channel may be indicated/transmitted through the MLME extension SAP in a period of Data/Management frame transmission or Channel Switching start.

According to the NGV standard, the anchor channel may be continually changed depending on a service. Accordingly, in the case that the MLME extension that performs a Multi-channel Operation informs the information for the anchor channel as well as SCH/CCH, there is an effect that overhead may be decreased in comparison with a signaling in PHY/MAC layer.

2) Channel Switch Announce Element

An NGV STA may indicate the information for the anchor channel through a Channel Switch Announce Element in the MAC layer. In other words, the Channel Switch Announce Element may include the information for the anchor channel.

In the NGV standard, for a BSS formation, a Beacon, a Probe Response, or a Channel Switch Announce frame may be transmitted. Accordingly, the Channel Switch Announce Element may be included in a Beacon, a Probe Response, or a Channel Switch Announce frame. In the case that the anchor channel continually changes, it is effective that the Channel Switch Announce Element is periodically transmitted. However, in this case, control overhead in a vehicle communication may become greater. Owing to this, since Service Latency becomes greater, the method described above may not be proper to a vehicle service.

3) New Element—NGV Operation Element

An NGV STA may define a new NGV Operation Element and indicate information for the anchor channel. That is, the NGV Operation Element may include the information for the anchor channel.

According to an embodiment, the NGV Operation Element may include information for a channel number for each 10 MHz channel.

According to an embodiment, the NGV Operation Element may include information for an Anchor channel number and an offset. The offset may mean a degree of separation of other 10 MHz channel from the anchor channel. Accordingly, the NGV STA may identify information for the anchor channel and other 10 MHz channel through the information for an Anchor channel number and an offset.

Similar to the method of section 2), in the NGV standard, a Beacon or a Probe Response for a BSS formation may be transmitted. Accordingly, the NGV Operation Element may be included in the Beacon or the Probe Response. In the case that the anchor channel continually changes, it is effective that the NGV Operation Element is periodically transmitted. However, in this case, control overhead in a vehicle communication may become greater. Owing to this, since Service Latency becomes greater, the method described above may not be proper to a vehicle service.

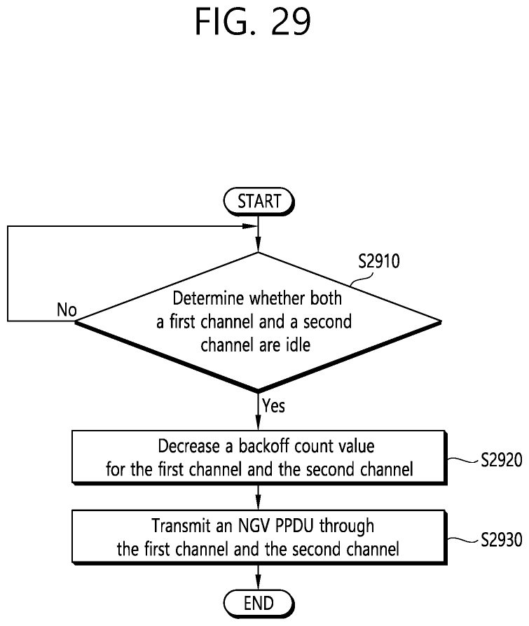

FIG. 29 is a flowchart for describing an operation of a transmission STA.

Referring to FIG. 29, in step S2910, a transmission STA (e.g., STA 110 or 120) may determine whether both a first channel and a second channel are idle. The transmission STA may support the NGV standard (i.e., 802.11bd standard). The transmission STA may include an NGV STA. The first channel and the second channel may be set to 10 MHz.

According to an embodiment, the transmission STA may determine whether a reception power of the first channel is a preset value or smaller. In addition, the transmission STA may determine whether a reception power of the second channel is a preset value or smaller. Thereafter, the transmission STA may determine whether both the first channel and the second channel are idle based on the condition that both reception powers of the first channel and the second channel are the preset value or smaller.

The preset value may be set to −85 dBm or −65 dBm. That is, the Sensitivity threshold (or the minimum modulation and coding rate sensitivity) may be identically set in both the first channel and the second channel for fairness. In addition, the Sensitivity threshold may be identically set to −85 dBm in both the first channel and the second channel.

For example, the transmission STA may identify that the first channel is busy based on the condition that a reception power of the first channel exceeds −85 dBm. Furthermore, the transmission STA may identify that the second channel is busy based on the condition that a reception power of the first channel exceeds −85 dBm.

On the contrary, the transmission STA may identify that the first channel is idle based on the condition that a reception power of the first channel exceeds −85 dBm. Furthermore, the transmission STA may identify that the second channel is idle based on the condition that a reception power of the first channel exceeds −85 dBm.

According to an embodiment, the transmission STA may determine whether reception powers of the first channel and the second channel are a preset value or lower through various detection methods. For example, the transmission STA may determine whether reception powers of the first channel and the second channel are a preset value or lower based on at least one of Preamble Detection (PD), Energy Detection (ED), or Guard Interval (GI) detection methods.

According to an embodiment, the transmission STA may determine whether reception powers of the first channel and the second channel are a preset value or lower based on the same detection method. For example, the transmission STA may determine whether reception powers of the first channel and the second channel are a preset value or lower based on the Energy Detection (ED) method.

According to an embodiment, the transmission STA may determine whether reception powers of the first channel and the second channel are a preset value or lower based on different detection methods. For example, the transmission STA may determine whether a reception power of the first channel is a preset value or lower based on the Preamble Detection (PD) method. In addition, the transmission STA may determine whether a reception power of the second channel is a preset value or lower based on the Energy Detection (ED) method.

According to an embodiment, the process of determining whether reception powers of the first channel and the second channel are a preset value or lower may be sequentially performed or simultaneously performed.

The conventional STA determines whether a channel is idle in a unit of 20 MHz. According to the embodiment described above, the transmission STA may determine whether a channel is idle in a unit of 10 MHz. Accordingly, there is an effect that the fairness of the first channel and the second channel is improved.

In step S2920, the transmission STA may decrease a backoff count value for the first channel and the second channel based on the condition that both the first channel and the second channel are idle. According to an embodiment, the backoff count value may be set to one backoff count value for the first channel and the second channel. In other words, the backoff count value may be set to a common backoff count value for the first channel and the second channel.

According to an embodiment, the transmission STA may decrease the backoff count value in every single slot. For example, the transmission STA may decrease the backoff count value to as low as {1} based on the condition that both the first channel and the second channel are idle in the first slot. Likewise, the transmission STA may decrease the backoff count value to as low as {1} based on the condition that both the first channel and the second channel are idle in the second slot. The transmission STA may decrease the backoff count value until the backoff count value set to the first value.

According to an embodiment, the transmission STA may maintain the backoff count value in the case that at least one of the first channel and the second channel is not idle in a single slot.

In step S2930, the transmission STA may transmit an NGV (Next Generation Vehicular) PPDU (Physical Protocol Data Unit) through the first channel and the second channel based on the condition that the backoff count value is set to the first value. That is, the NGV PPDU may be transmitted in a 20 MHz bandwidth. According to an embodiment, the NGV PPDU may be transmitted in 5.9 GHz band.

The technical feature of the present disclosure described above may be applied to various apparatuses and methods. For example, the technical feature of the present disclosure may be performed/supported by the apparatus shown in FIG. 1 and/or FIG. 19. For example, the technical feature of the present disclosure may be applied to only a part shown in FIG. 1 and/or FIG. 19. For example, the technical feature of the present disclosure may be implemented based on the processor chip 114 or 124 shown in FIG. 1, may be implemented based on the processor 111 or 121 and the memory 112 or 122 shown in FIG. 1, or may be implemented based on the processor 610 and the memory 620 shown in FIG. 1. For example, the apparatus of the present disclosure may include a memory and a processor which is operably coupled with the memory, and the processor may be configured to determine whether both the first channel set to 10 MHz and the second channel set to 10 MHz are idle, decrease a backoff count value for the first channel and the second channel based on the determination that both the first channel and the second channel are idle, and transmit an NGV (Next Generation Vehicular) PPDU (Physical Protocol Data Unit) through the first channel and the second channel based on the condition that the backoff count value is set to the first value.

The technical feature of the present disclosure may be implemented based on a computer readable medium (CRM). For example, the CRM proposed in the present disclosure may store instructions that perform operations including determining whether both the first channel set to 10 MHz and the second channel set to 10 MHz are idle; decreasing a backoff count value for the first channel and the second channel based on the condition that both the first channel and the second channel are idle; and transmitting an NGV (Next Generation Vehicular) PPDU (Physical Protocol Data Unit) through the first channel and the second channel based on the condition that the backoff count value is set to the first value. The command stored in the CRM of the present disclosure may be executed by at least one processor. The at least one processor in relation to the CRM of the present disclosure may be the processor 111 or 121 shown in FIG. 1, the processor chip 114 or 124, or the processor 610 shown in FIG. 19. Meanwhile, the CRM of the present disclosure may be the memory 112 or 122 shown in FIG. 1, the memory 620 shown in FIG. 19, or a separate external memory/storage medium/disk, and the like.

The technical feature of the present disclosure described above may be applied to various applications or business models. For example, the UE, the terminal, the STA, the transmitter, the receiver, the processor, and/or the transceiver described in the present disclosure may be applied to a vehicle supporting autonomous driving or the conventional vehicle supporting autonomous driving.

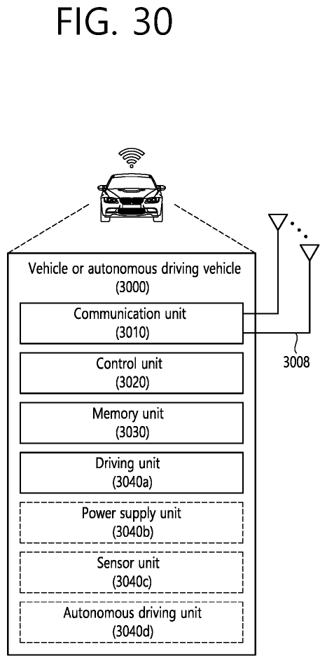

FIG. 30 illustrates a vehicle or autonomous driving vehicle applied to the present disclosure. The vehicle or the autonomous driving vehicle may be implemented with a mobile robot, a vehicle, a train, a manned/unmanned aerial vehicle (AV), a ship, and the like.

A memory unit 3030 shown in FIG. 30 may be included in the memory 112 or 122 shown in FIG. 1. In addition, a communication unit 3010 shown in FIG. 30 may be included in the transceiver 113 or 123 and/or the processor 111 or 121 shown in FIG. 1. Furthermore, the remaining devices shown in FIG. 30 may be included in the processor 111 or 121 shown in FIG. 1.

Referring to FIG. 30, a vehicle or autonomous driving vehicle 3000 may include an antenna 3008, the communication unit 3010, a control unit 3020, the memory unit 3030, a driving unit 3040a, a power supply unit 3040b, a sensor unit 3040c, and/or an autonomous driving unit 3040d. The antenna 3008 may be constructed as a part of the communication unit 3010.

The communication unit 3010 may transmit and receive a signal (e.g., data, control signal, etc.) with another vehicle, base station (e.g., base station, road side base station (Road Side Unit), etc.), and a server. The control unit 3020 may control elements of the vehicle or autonomous driving vehicle 3000 and perform various operations. The control unit 3020 may include an ECU (Electronic Control Unit). The driving unit 3040a may drive the vehicle or autonomous driving vehicle 3000 on a road. The driving unit 3040a may include an engine, a motor, a power train, a wheel, a brake, a steering device, and the like. The power supply unit 3040b may supply power to the vehicle or autonomous driving vehicle 3000 and include a wired/wireless charging circuit, a battery, and the like. The sensor unit 3040c may obtain a vehicle state, neighboring environment information, user information, and the like. The sensor unit 3040c may include an IMU (inertial measurement unit) sensor, a collision sensor, a wheel sensor, a velocity sensor, a slope sensor, a weight sensor, a heading sensor, a position module, a vehicle forward driving/backward driving sensor, a battery sensor, a fuel sensor, a tire sensor, a steering sensor, a temperature sensor, a humidity sensor, an ultrasonic sensor, a luminance sensor, a pedal position sensor, and the like. The autonomous driving unit 3040d may implement a technique of maintaining a driving vehicle line, a technique of automatically adjusting a speed such as an adaptive cruise control, a technique of automatically driving along a predetermined path, a technique of driving by configuring a route automatically when a destination is set, and the like.

In one example, the communication unit 3010 may receive a map data, traffic information data, and the like from an external server. The autonomous driving unit 3040d may generate an autonomous driving route and a driving plan based on the obtained data. The control unit 3020 may control the driving unit 3040a such that the autonomous driving unit 3040d moves along the autonomous driving route according to the driving plan (e.g., velocity/direction control). During the autonomous driving, the communication unit 3010 may obtain the latest traffic information data nonperiodically/periodically from the external server and obtain neighboring traffic information data from a neighboring vehicle. Furthermore, during the autonomous driving, the sensor unit 3040c may obtain a vehicle state and neighboring environment information. The autonomous driving unit 3040d may update the autonomous driving route according to the driving plan based on newly obtained data/information. The communication unit 3010 may forward information for the autonomous driving route according to the driving plan to the external server. The external server may predict traffic information data by using AI technique based on the information collected from a vehicle or autonomous driving vehicles and provide the predicted traffic information data to the vehicle or autonomous driving vehicles.

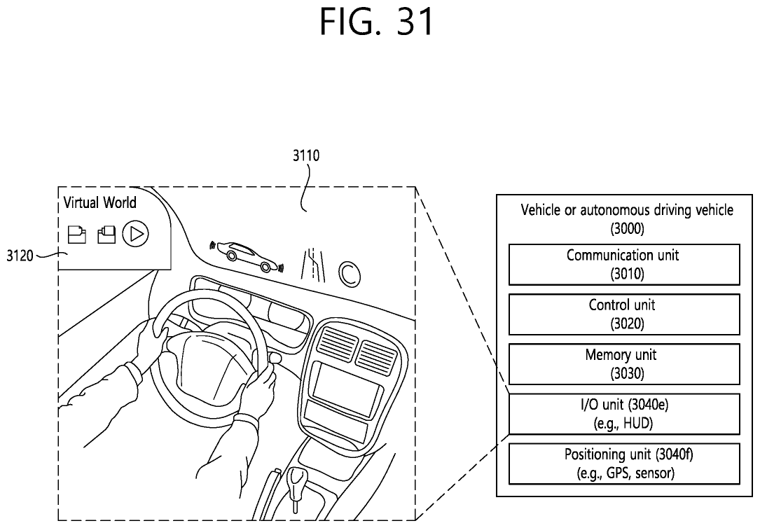

An example of the present disclosure includes an example of FIG. 31 described below.

FIG. 31 illustrates an example of a vehicle based on the present disclosure. The vehicle may be implemented with a transportation means, a train, an airplane, a ship, and the like.

Referring to FIG. 31, a vehicle 3000 may include a communication unit 3010, a control unit 3020, a memory unit 3030, an input/output unit 3040e, and a positioning unit 3040f. Each of the block/unit/device shown in FIG. 31 may be the same as the block/unit/device shown in FIG. 30.

The communication unit 3010 may transmit and receive a signal (e.g., data, control signal, etc.) with another vehicle or external devices such as a base station. The control unit 3020 may control constituent elements of the vehicle 3000 and perform various operations. The memory unit 3030 may store data/parameter/program/code/command that supports various functions of the vehicle 3000. The input/output unit 3040e may output an AR/VR object based on information in the memory unit 3030. The input/output unit 3040e may include an HUD. The positioning unit 3040f may obtain position information of the vehicle 3000. The position information may include absolute position information, position information in a driving lane, acceleration information, position information with respect to a neighboring vehicle, and the like. The positioning unit 3040f may include GPS and various sensors.

In one example, the communication unit 3010 of the vehicle may receive map information and traffic information from an external server and store the information in the memory unit 3030. The positioning unit 3040f may obtain vehicle position information through the GPS and the various sensors and store the vehicle position information in the memory unit 3030. The control unit 3020 may generate a virtual object based on the map information, the traffic information, and the vehicle position information, and the input/output unit 3040e may display the generated virtual object on a window in the vehicle (steps 3110 and 3120). Furthermore, the control unit 3020 may determine whether the vehicle 300 is normally driving in the driving lane based on the vehicle position information. In the case that the vehicle 300 deviates from the driving lane abnormally, the control unit 3020 may display warning on the window in the vehicle through the input/output unit 3040e. In addition, the control unit 3020 may broadcast a warning message related to the abnormal driving to neighboring vehicles through the communication unit 3010. Depending on a situation, the control unit 3020 may transmit the position information of the vehicle and information for driving/vehicle abnormality to a related agency through the communication unit 3010.

The foregoing technical features of this specification are applicable to various applications or business models.

For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A wireless local area network system, comprising:
determining, by a transmission STA, whether both a first channel set to 10 MHz and a second channel set to 10 MHz are idle;
decreasing, by the transmission STA, a backoff count value for the first channel and the second channel based on the determination that both the first channel and the second channel are idle; and
transmitting, by the transmission STA, a Next Generation Vehicular (NGV) Physical Protocol Data Unit (PPDU) through the first channel and the second channel based on a condition that the backoff count value is set to a first value.

2. The method of claim 1, further comprising:
determining, by the transmission STA, whether a reception power of the first channel is a preset value or smaller;
determining, by the transmission STA, whether a reception power of the second channel is a preset value or smaller; and
determining, by the transmission STA, whether both the first channel and the second channel are idle based on a condition that both the reception powers of the first channel and the second channel are the preset value or smaller.

3. The method of claim 2, wherein the preset value is set to −85 dBm or −65 dBm.

4. The method of claim 1, wherein the backoff count value is set to one backoff count value for the first channel and the second channel.

5. The method of claim 1, wherein the first value is set to {0}.

6. The method of claim 1, wherein the NGV PPDU is transmitted in 5.9 GHz band, and wherein the NGV PPDU is transmitted in a bandwidth of 20 MHz.

7. A transmission STA used in a wireless local area network system, comprising:
a transceiver configured to receive a radio signal; and
a processor configured to control the transceiver,
wherein the processor is configured to:
determine whether both a first channel set to 10 MHz and a second channel set to 10 MHz are idle;
decrease a backoff count value for the first channel and the second channel based on the determination that both the first channel and the second channel are idle; and
transmit a Next Generation Vehicular (NGV) Physical Protocol Data Unit (PPDU) through the first channel and the second channel based on a condition that the backoff count value is set to a first value.

8. The transmission STA of claim 7, wherein the processor is further configured to:
determine whether a reception power of the first channel is a preset value or smaller;
determine whether a reception power of the second channel is a preset value or smaller; and
determine whether both the first channel and the second channel are idle based on a condition that both the reception powers of the first channel and the second channel are the preset value or smaller.

9. The transmission STA of claim 8, wherein the preset value is set to −85 dBm or −65 dBm.

10. The transmission STA of claim 7, wherein the backoff count value is set to one backoff count value for the first channel and the second channel.

11. The transmission STA of claim 7, wherein the first value is set to {0}.

12. The transmission STA of claim 7, wherein the NGV PPDU is transmitted in 5.9 GHz band, and wherein the NGV PPDU is transmitted in a bandwidth of 20 MHz.

13. (canceled)

14. An apparatus on a wireless local area network system, comprising:
a memory; and
a processor operably coupled with the memory,
wherein the processor is configured to:
determine whether both a first channel set to 10 MHz and a second channel set to 10 MHz are idle;
decrease a backoff count value for the first channel and the second channel based on the determination that both the first channel and the second channel are idle; and
transmit a Next Generation Vehicular (NGV) Physical Protocol Data Unit (PPDU) through the first channel and the second channel based on a condition that the backoff count value is set to a first value.
